(19) United States
(12) Patent Application Publication
(10) Pub. No.: US 2026/0263931 A1
(43) Pub. Date: Sep. 10, 2026

(54) METHOD AND APPARATUS FOR CASTING SKILL, DEVICE, AND STORAGE MEDIUM

(71) Applicant: Tencent Technology (Shenzhen) Company Limited, Shenzhen (CN)

(72) Inventors: Linying XIE, Shenzhen (CN); Jiaqi PAN, Shenzhen (CN); Ying DENG, Shenzhen (CN); Weixiang YU, Shenzhen (CN); Wenyi LI, Shenzhen (CN); Yinglei WANG, Shenzhen (CN); Yun YANG, Shenzhen (CN)

(21) Appl. No.: 19/662,856

(22) Filed: Apr. 29, 2026

Related U.S. Application Data
(63) Continuation of application No. PCT/CN2025/079048, filed on Feb. 25, 2025.

(30) Foreign Application Priority Data
Feb. 29, 2024 (CN) 202410232516.2

(51) Int. Cl. A63F 13/533; A63F 13/5375; A63F 13/56; A63F 13/847

(52) U.S. Cl. CPC A63F 13/533; A63F 13/5375; A63F 13/56; A63F 13/847

(57) ABSTRACT

This application discloses a method for casting a skill in a virtual environment performed by a computer device. The method includes: displaying, in a graphical user interface, a virtual environment including skill icons of skills respectively possessed by at least two team-member virtual characters controlled by team members belonging to a same team as a user of the computer device; in response to a marking operation sequentially performed on at least two skills by the user of the computer device, displaying marking serial numbers respectively corresponding to the at least two skills, each marking serial number indicating a suggested casting order of a current skill among the at least two skills; and sequentially triggering transmission of casting prompt information to a team member corresponding to each skill among the at least two skills. In this application, the communication and command process between the captain and the team members is simplified.

### CROSS-REFERENCE TO RELATED APPLICATIONS

This application is a continuation application of PCT Patent Application No. PCT/CN2025/079048, entitled “METHOD AND APPARATUS FOR CASTING SKILL, DEVICE, AND STORAGE MEDIUM” filed on February 25, 2025, which claims priority to Chinese Patent Application No. 202410232516.2, entitled "METHOD AND APPARATUS FOR CASTING SKILL, DEVICE, AND STORAGE MEDIUM" and filed on February 29, 2024, all of which are incorporated herein by reference in their entirety.

### FIELD OF THE TECHNOLOGY

This application relates to the field of human-computer interaction, and to a method and apparatus for casting a skill, a device, and a storage medium.

### BACKGROUND OF THE DISCLOSURE

In a multiplayer online battle arena (MOBA) game, virtual characters are typically configured with a plurality of skills, and a plurality of players can cooperatively control these virtual characters to cast skills during a fight.

Current gaming environments rely on voice commands or text information to coordinate skill casting among teammates during team fights. This requires a plurality of players to effectively deliver and receive instructions during the game. In this way, the plurality of players need to possess high levels of gaming experience and the ability to communicate in real time.

However, for inexperienced players, being unfamiliar with teammates' behavior patterns may lead to problems of poor coordination and low execution efficiency. Moreover, a noisy gaming environment or situations where players are unfamiliar with the language being used can hinder instruction delivery, resulting in performance mistakes.

### SUMMARY

This application provides a method and apparatus for casting a skill, a device, and a storage medium. The technical solutions are as follows.

According to an aspect of this application, a method for casting a skill in a virtual environment is performed by a computer device and the method includes: displaying, in a graphical user interface, a virtual environment including skill icons of skills respectively possessed by at least two team-member virtual characters, the team-member virtual characters being controlled by team members belonging to a same team as a user of the computer device; in response to a marking operation sequentially performed on at least two skills by the user of the computer device, displaying marking serial numbers respectively corresponding to the at least two skills, each marking serial number indicating a suggested casting order of a current skill among the at least two skills; and sequentially triggering transmission of casting prompt information to a team member corresponding to each skill among the at least two skills.

According to another aspect of this application, a computer device is provided, including a processor and a memory, the memory having a computer program stored therein, and the computer program, when executed by the processor, causing the computer device to implement the method for casting a skill in a virtual environment as described above.

According to another aspect of this application, a non-transitory computer-readable storage medium is provided, having executable instructions stored therein, the executable instructions, when executed by a processor of a computer device, causing the computer device to implement the method for casting a skill in a virtual environment as described above.

The technical solutions provided in the embodiments of this application include at least the following beneficial effects:

The embodiments of this application provide a method for casting a skill. The marking serial numbers respectively corresponding to at least two skills are displayed according to the marking order in response to the marking operation sequentially performed on the at least two skills, each marking serial number being configured for indicating the suggested casting order of the current skill among the at least two skills. The transmission of the casting prompt information to the team member corresponding to each skill among the at least two skills is sequentially triggered according to the marking serial numbers, the casting prompt information being configured for instructing the team member to cast the skill. The skills of team members in a team are marked by a captain, thereby commanding the team members to cast the skills in an order. The casting prompt information is configured for prompting a team member that the captain recommends casting the skill. The captain and team members do not need to frequently perform a voice conversation or a text chat to transmit information for recommending the team members to cast the skills. The communication and command process between the captain and the team members is simplified, thereby reducing information transmission errors and time delays and improving the efficiency of participating in a virtual arena by the team in a virtual environment.

### BRIEF DESCRIPTION OF THE DRAWINGS

FIG. 1 illustrates a schematic diagram of an architecture of a computer system provided by an exemplary embodiment of this application.

FIG. 2 illustrates a schematic diagram of a method for casting a skill provided by an exemplary embodiment of this application.

FIG. 3 illustrates a flowchart of a method for casting a skill provided by an exemplary embodiment of this application.

FIG. 4 illustrates a schematic diagram of a method for casting a skill provided by an exemplary embodiment of this application.

FIG. 5 illustrates a schematic diagram of a method for casting a skill provided by an exemplary embodiment of this application.

FIG. 6 illustrates a flowchart of a method for casting a skill provided by an exemplary embodiment of this application.

FIG. 7 illustrates a schematic diagram of a method for casting a skill provided by an exemplary embodiment of this application.

FIG. 8 illustrates a flowchart of a method for casting a skill provided by an exemplary embodiment of this application.

FIG. 9 illustrates a schematic diagram of a method for casting a skill provided by an exemplary embodiment of this application.

FIG. 10 illustrates a flowchart of a method for casting a skill provided by an exemplary embodiment of this application.

FIG. 11 illustrates a schematic diagram of a method for casting a skill provided by an exemplary embodiment of this application.

FIG. 12 illustrates a flowchart of a method for casting a skill provided by an exemplary embodiment of this application.

FIG. 13 illustrates a schematic diagram of a method for casting a skill provided by an exemplary embodiment of this application.

FIG. 14 illustrates a schematic diagram of a method for casting a skill provided by an exemplary embodiment of this application.

FIG. 15 illustrates a flowchart of a method for casting a skill provided by an exemplary embodiment of this application.

FIG. 16 illustrates a structural block diagram of an apparatus for casting a skill provided by an exemplary embodiment of this application.

FIG. 17 illustrates a structural block diagram of an apparatus for casting a skill provided by an exemplary embodiment of this application.

FIG. 18 illustrates a schematic structural diagram of a computer device provided by an exemplary embodiment of this application.

### DESCRIPTION OF EMBODIMENTS

In this application, before and during the collection of relevant data of a user, a prompt interface or a pop-up window may be displayed, or voice prompt information may be outputted. The prompt interface, the pop-up window, or the voice prompt information is configured for prompting the user that relevant data of the user is currently being collected. In this way, in this application, only after a confirmation operation performed by the user for the prompt interface or the pop-up window is obtained, the relevant operations of obtaining the relevant data of the user start to be performed. Otherwise (i.e., when no confirmation operation performed by the user for the prompt interface or the pop-up window is obtained), the relevant operations of obtaining the relevant data of the user are ended, i.e., the relevant data of the user is not obtained. In other words, all user data collected in this application is collected with consent and authorization of the user. In addition, collection, use, and processing of the relevant user data are required to comply with relevant laws, regulations, and standards of relevant countries and regions.

First, relevant terms involved in this application are introduced:

Virtual environment : It is a virtual environment displayed (or provided) when an application program runs on a terminal. The virtual environment may be a simulated world of the real world, may be a semi-simulated and semi-fictional three-dimensional world, or may be a purely fictional three-dimensional world. The virtual environment may be any one of a two-dimensional virtual environment, a 2.5-dimensional virtual environment, and a three-dimensional virtual environment. In one embodiment, the virtual environment is further configured for a virtual environment battle between at least two virtual characters, and there are virtual resources available for use by the at least two virtual characters in the virtual environment.

Virtual character: It is a movable object controlled by artificial intelligence (AI) in a virtual environment. The movable object may be at least one of a virtual character, a virtual animal, or a cartoon character. In one embodiment, when the virtual world is a three-dimensional virtual world, the virtual character may be a three-dimensional virtual model. Each virtual character has its own shape and volume in the three-dimensional virtual world, and occupies part of space in the three-dimensional virtual world. In one embodiment, a virtual character is constructed based on a three-dimensional human skeleton technology. The virtual character presents different external appearances by wearing different skins. In some implementations, the virtual character may alternatively be implemented by using a 2.5-dimensional model or 2-dimensional model. This is not limited in the embodiments of this application.

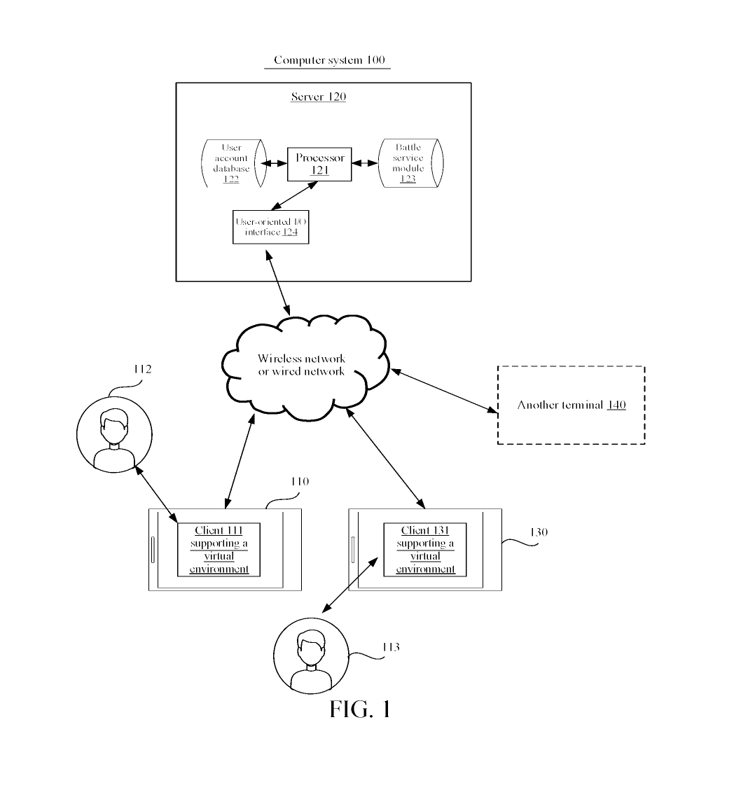

FIG. 1 illustrates a schematic diagram of a computer system provided by an exemplary embodiment of this application. The computer system 100 may include a first terminal device 110, a server 120, and a second terminal device 130. A client 111 supporting a virtual environment is installed and runs on the first terminal device 110. The client 111 may be a multiplayer online battle arena program. When the first terminal device 110 runs the client 111, a user interface of the client 111 is displayed on the screen of the first terminal device 110. The client 111 may be any one of a multiplayer online game, a battle royale shooting game, a virtual reality (VR) application program, an augmented reality (AR) program, a three-dimensional map program, a VR game, an AR game, a first-person shooting (FPS) game, a third-person shooting (TPS) game, an MOBA game, and a simulation game (SLG). In this embodiment, an example in which the client 111 is an MOBA game is used for description. The first terminal device 110 is a terminal used by a first user 112. The first user 112 uses the first terminal device 110 to control a first virtual character in a virtual environment to perform an action, or to operate a virtual item possessed by the first virtual character. The first virtual character may be referred to as the virtual character of the first user 112. The first user 112 may perform operations such as assembling, disassembling, and unloading on the virtual item possessed by the first virtual character. This is not limited in this application. For example, the first virtual character is a gaming virtual character such as a simulated character or a cartoon character. An example in which the client 111 is implemented by a first client is used in an embodiment of this application for description. In one embodiment, the first client is usually a client corresponding to the captain of a team, or may be a client of a team member having a command permission.

A client 131 supporting a virtual environment is installed and runs on the second terminal device 130. The client 131 may be a multiplayer online battle arena program. When the second terminal device 130 runs the client 131, a user interface of the client 131 is displayed on the screen of the second terminal device 130. This client may be any one of an MOBA game, a battle royale shooting game, a VR application program, an AR program, a three-dimensional map program, a VR game, an AR game, an FPS game, a TPS game, and an SLG. The second terminal device 130 is a terminal used by a second user 113. The second user 113 uses the second terminal device 130 to control a second virtual character in the virtual environment to perform an action and to operate a virtual item possessed by the second virtual character. The second virtual character may be referred to as the virtual character of the second user 113. For example, the second virtual character is a gaming virtual character such as a simulated character or a cartoon character. An example in which the client 131 is implemented by a second client is used in an embodiment of this application for description. In one embodiment, the second client is a client corresponding to a common team member having no command permission.

In one embodiment, the first virtual character and the second virtual character are in the same virtual environment. In one embodiment, the first virtual character and the second virtual character may belong to the same camp, the same team, the same organization, have a friend relationship, or have temporary communication permission. In one embodiment, the clients installed on the first terminal device 110 and the second terminal device 130 are the same, or the clients installed on two terminals are the same type of clients on different operating system platforms (Android or IOS). The first terminal device 110 may refer to one of a plurality of terminals, and the second terminal device 130 may refer to another one of the plurality of terminals. This embodiment uses only the first terminal device 110 and the second terminal device 130 as an example for description. The first terminal device 110 and the second terminal device 130 are of the same or different device types, including at least one of a smartphone, a tablet computer, an e-book reader, a moving picture experts group audio layer III (MP3) player, a moving picture experts group audio layer IV (MP4) player, a laptop computer, and a desktop computer.

Only two terminals are shown in FIG. 1. However, in different embodiments, there may be a plurality of other terminals 140 that can access the server 120. In one embodiment, there are alternatively one or more terminals 140 that correspond to a developer. A development and editing platform for a client that supports a virtual environment is installed on the terminal 140. The developer may edit and update the client on the terminal 140, and transmit an updated client installation package to the server 120 over a wired or wireless network. The first terminal device 110 may download the client installation package from the server 120 to update the client.

The server 120 includes at least one of one server, a plurality of servers, a cloud computing platform, and a virtualization center. The server 120 is configured to provide a background service for the client 111. In one embodiment, the server 120 undertakes main computing work, and the first terminal device 110 undertakes secondary computing work. Alternatively, the server 120 undertakes the secondary computing work, and the first terminal device 110 undertakes the main computing work. Alternatively, the server 120 and the first terminal device 110 perform collaborative computing by using a distributed computing architecture. In one embodiment, the server 120 includes a processor 121, a user account database 122, a battle service module 123, and a user-oriented input/output (I/O) interface 124. The processor 121 is configured to load instructions stored on the server 120, and process data in the user account database 122 and the battle service module 123. The user account database 122 is configured to store data of user accounts used by the first terminal device 110 and another terminal 140, such as avatars of the user accounts, names of the user accounts, fighting power indexes of the user accounts, and service areas of the user accounts. The battle service module 123 is configured to provide a plurality of battle rooms for users to battle, such as a 1V1 battle room, a 3V3 battle room, and a 5V5 battle room. The user-oriented I/O interface 124 is configured to establish communication with the first terminal device 110 and/or another terminal 140 via a wireless network or a wired network for data exchange. The first terminal device 110, the second terminal device 130, and another terminal 140 are connected to the server 120 via a wireless network or a wired network.

In some embodiments, the first terminal device 110 and the second terminal device 130 transmit operation data of users in a game battle to the server 120. The server 120 receives the operation data, and processes the operation data to obtain a processing result. The server 120 separately transmits the processing result to the first terminal device 110 and the second terminal device 130.

In this method, the first terminal device 110 can control the first virtual character to cast a skill to the virtual environment. Besides, a skill casting prompt is transmitted to the second terminal device 130 in the game battle, such that the second terminal device 130 controls the second virtual character to cast a skill to the virtual environment. Compared to the common problems, such as audio lag, language barriers, and ambient noise, in voice-based communication among users, this method is helpful for enhancing communication efficiency, is unaffected by the user's gaming environment, and offers good universality. For specific details of this method, please refer to the description below.

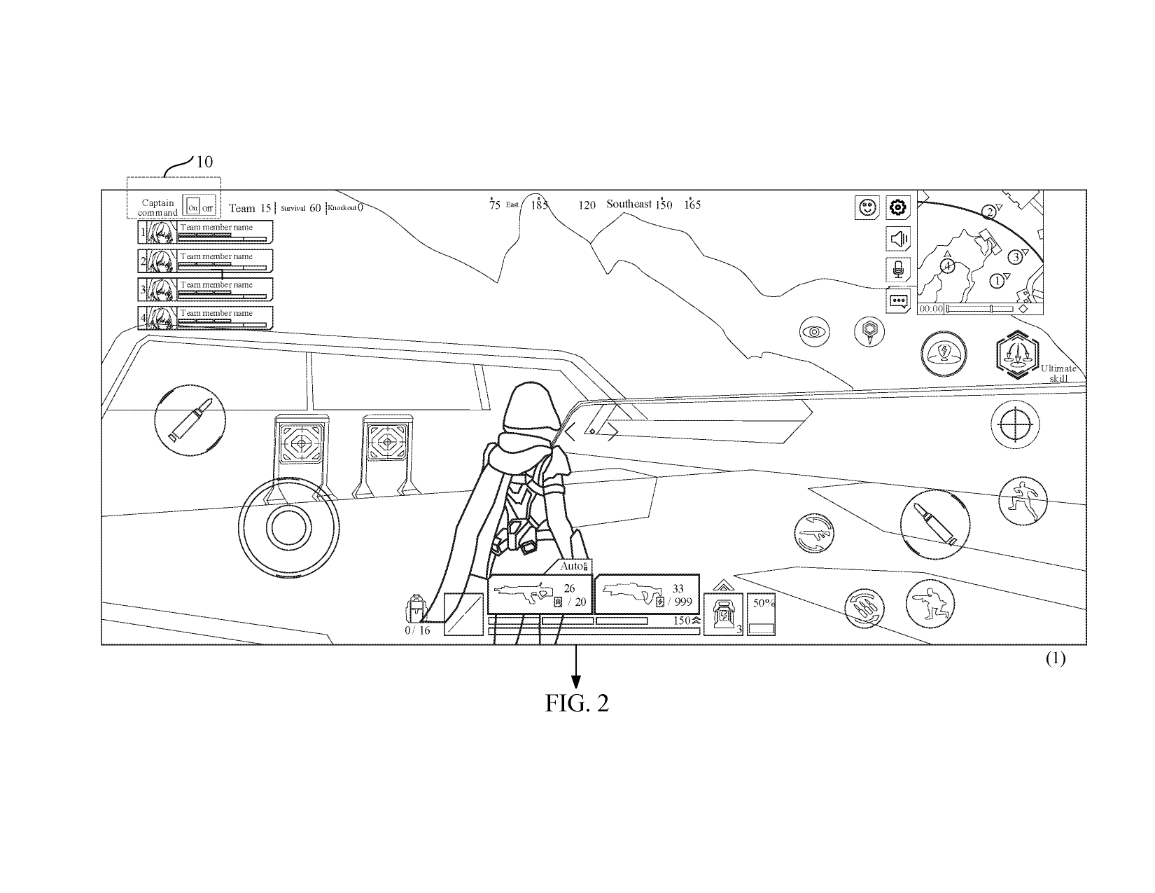

For example, FIG. 2 illustrates a schematic diagram of a method for casting a skill provided by an exemplary embodiment of this application. An example in which this method is performed by the client 111 supporting the virtual environment is used for description.

During a team battle, a plurality of players need to coordinate with one another to cast skills. For example, the plurality of players coordinate, through voice communication or text information, teammates to control skill casting. This requires the plurality of players to effectively deliver and receive instructions during the game. In this way, the plurality of players need to possess high levels of gaming experience and the ability to communicate in real time. However, when the players are inexperienced, or communication among the plurality of players is not performed in real time, a problem of performance mistakes may be caused.

In view of the above problems, an embodiment of this application provides a method for casting a skill. The skills of team members in a team are marked by a captain, and an order of casting the skills by the team members is instructed according to a marking order, thereby helping the team members intuitively master which skills are to be cast and when the skills are cast. Thus, the communication and command process among a plurality of players is simplified.

With reference to FIG. 2, the method for casting a skill according to the embodiments of this application is described briefly below.

A command control 10 in a virtual scene is displayed.

The command control 10 includes an on state and an off state. The command control is configured for a captain or a team member having a command permission to enable or disable the command permission. As shown in FIG. 2 (1), the command control 10 is an interface element, which is usually composed of a text and a switch button. A captain or a team member having a command permission in a team battle may enable or disable the command permission in real time via the command control 10. An example in which the captain enables the command permission is used for description in the embodiments of this application.

Skill icons 20 of skills respectively possessed by at least two team-member virtual characters are displayed in response to a command enabling operation on the command control 10.

The team-member virtual character is a virtual character belonging to the same team as the captain. The skill icon 20 includes a skill name and a skill state of each skill.

The skill name is a specific name of a skill possessed by a virtual character that is currently in a survival state. As shown in FIG. 2 (2), taking as an example that four players participate in the team battle, during an initial battle, a game interface corresponding to the captain displays the skill icons 20 of the skills respectively possessed by at least two team-member virtual characters in response to triggering of the captain for the command control 10.

The skill state refers to a current state of a skill possessed by a virtual character in the game. In one embodiment, the skill state includes a ready state or a cooldown state. The ready state indicates that the skill is ready and may be immediately cast or used. The cooldown state indicates that a skill is being cooled down and can be used again after a preset time.

A skill in the ready state is switched to a marked state 30 in response to a clicking/tapping operation on the skill.

In one embodiment, when the captain clicks/taps on a skill in the ready state, the skill is switched to the marked state 30. Meanwhile, a current marking serial number is displayed at the top right corner of the skill icon corresponding to the skill. The marking serial number is configured for indicating the suggested casting order of the current skill among at least two skills. In one embodiment, the captain may continuously mark a plurality of skills in the ready state, and switch the plurality of skills to the marked state 30. Meanwhile, the current marking serial numbers are displayed at the top right corners of the skill icons corresponding to the plurality of skills. The marking serial number is updated to n+1, n being the number of marked skills still in the sequence before the current marking. For example, with reference to FIG. 2 (2), the captain clicks/taps on a first skill in the ready state, and marks and switches the first skill to be the marked state, with the marking serial number of the first skill being 1. The captain clicks/taps on a second skill in the ready state, and marks and switches the second skill to be the marked state, with the marking serial number of the second skill being 2. The skill with the marking serial number 1 is cast in an order before the skill with the marking serial number 2.

In one embodiment, after the captain sequentially performs the marking operation on at least two skills, the marking serial numbers are displayed at the top right corners of the marked skills, and transmission of casting prompt information to the team member corresponding to each skill among the at least two skills is sequentially triggered according to the marking serial numbers.

Taking the marked skills as an example, first, the casting prompt information is transmitted to the team member corresponding to the skill with the marking serial number 1. The casting prompt information is configured for instructing the team member to cast the skill with the marking serial number 1. After the team member casts the skill with the marking serial number 1, the skill with the marking serial number 2 becomes the skill with the marking serial number 1. The casting prompt information is transmitted to the team member corresponding to the skill of which the marking serial number is originally 2 (now 1). The casting prompt information is configured for instructing the team member to cast the skill of which the marking serial number is originally 2 (now 1).

A prompt of a skill state corresponding to a skill in the cooldown state is displayed in response to a clicking/tapping operation on the skill.

When a skill is in the cooldown state, a cooldown progress circle is usually displayed on the skill icon corresponding to the skill to indicate the cooldown progress of the skill. In one embodiment, the cooldown progress circle displays a ratio of a current remaining time to a total cooldown time to visually show the skill cooldown progress.

In one embodiment, when the captain clicks/taps on a skill in the cooldown state, a prompt appears at the top of the game interface of the captain. This prompt is configured for displaying the remaining time for cooldown of the skill. In one embodiment, the prompt may be presented in a text form, for example, "Skill is being cooled down …", or the prompt is a progress bar for countdown, which displays the remaining time for cooldown of the skill.

For the captain or the team member having the command permission:

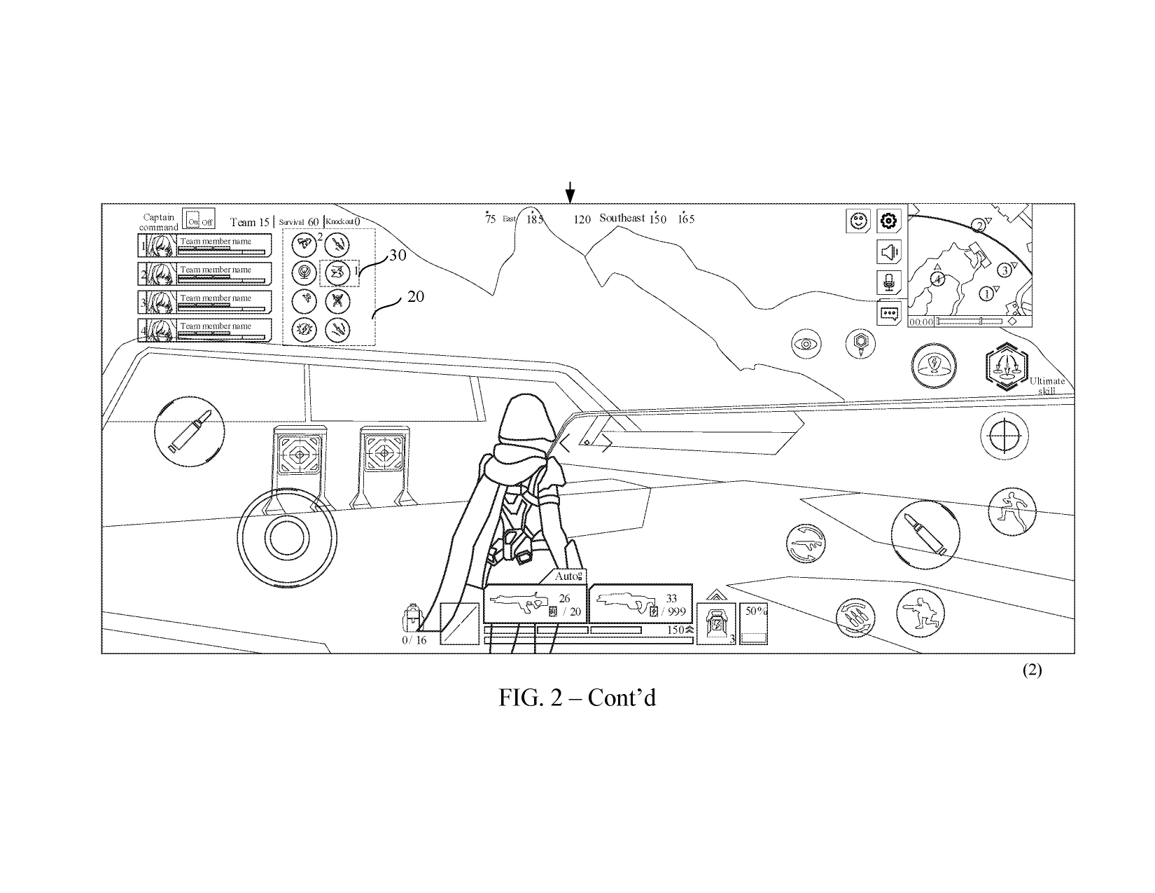

FIG. 3 illustrates a flowchart of a method for casting a skill provided by an exemplary embodiment of this application. The method may be performed by a first client. An example in which the method is applied to the terminal device 110 shown in FIG. 1 is used for description. The method includes operation 220, operation 240, and operation 260 as follows.

Operation 220: Display skill icons of skills respectively possessed by at least two team-member virtual characters. In some embodiments, the terminal device 110 displays, in a graphical user interface, a virtual environment including skill icons of skills respectively possessed by at least two team-member virtual characters. The team-member virtual characters are controlled by team members belonging to a same team as a user of the computer device.

In some embodiments, a first client supporting a virtual environment runs on the terminal device. A game interface of the first client displays the skill icons of the skills respectively possessed by at least two team-member virtual characters in the virtual environment. The virtual environment is a virtual environment for a plurality of virtual characters to battle against each other. The plurality of virtual characters include a captain virtual character and team-member virtual characters. The captain virtual character and the team-member virtual characters belong to the same team. The captain virtual character is a virtual character controlled by the captain, and the team-member virtual characters are other virtual characters controlled by team members in the team. The team-member virtual characters are virtual characters controlled by team members belonging to the same team. The team member also refers to a team member account or a team member user.

In the following embodiments, a team commander transmitting an instruction to team members may be understood as the team commander transmitting the instruction to team member accounts via a team commander account. The team commander is a person having a command permission, who may be the captain or may be a team member having the command permission. This application is described by taking the captain as an example, but this does not constitute a limitation to the team commander. In some embodiments, skills respectively possessed by the captain virtual character and the team-member virtual characters may be displayed via skill icons. The skill icons refer to icons or buttons for representing different skills on the game interface. The skill icons are configured to help the captain or the team members quickly recognize and select corresponding skills for use. In one embodiment, the captain or the team members may cast the corresponding skills by clicking/tapping the skill icons. In one embodiment, the skill icons may be in various shapes and colors, and are usually associated with characteristics or effects of the corresponding skills. For example, an "exploding" skill may have an exploding icon, a "bombing" skill may have a bombing icon, and an "accelerating" skill may have a running icon. In one embodiment, the skill icon further includes a skill name corresponding to the skill, and the skill name is the name of the skill possessed by the virtual character that is currently in the survival state. In one embodiment, the skill icon further includes a skill state corresponding to the skill. The skill state includes a ready state and a cooldown state. The skill state refers to the current availability or capability of being cast of a skill.

In some embodiments, taking as an example that the team includes n team-member virtual characters, during an initial battle, the skill icons of the skills respectively possessed by the n team-member virtual characters are displayed on the game interface corresponding to the first client; and when the team includes n-1 team-member virtual characters in the survival state, the skill icons of the skills respectively possessed by the n-1 team-member virtual characters are displayed on the game interface corresponding to the first client, n being a positive integer.

In an implementation, the skill icon corresponding to a skill in the ready state in the virtual environment is displayed on the game interface of the first client. The skill in the ready state indicates that the skill may be used or cast immediately.

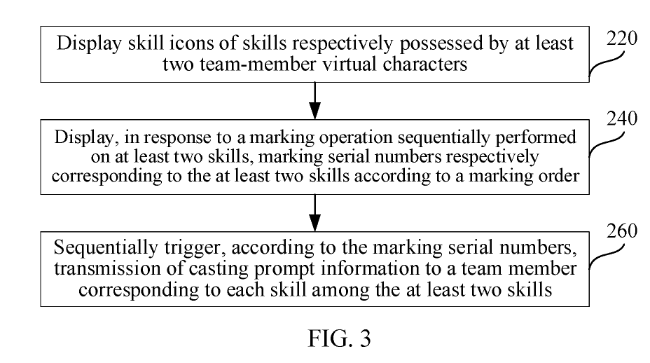

In some embodiments, the captain virtual character and the team-member virtual characters may have a first preset number of skills. Each virtual character may have a second preset number of skills, and skills of different virtual characters may be the same or different. This is not limited in this application. As shown in FIG. 4, the skill icons 302 of the skills respectively possessed by four virtual characters including the captain virtual character are displayed on the game interface 301 corresponding to the first client. The skill icon of each skill includes a pattern and a skill name corresponding to the skill. For example, the skill icons corresponding to different skill names such as "teleporting", "exploding", "blinking", and "transfer" are displayed on the game interface 301. In one embodiment, different virtual characters may have the same skill. For instance, both a second team-member virtual character and a third team-member virtual character in a teammate list 303 have a "stealth" skill. Different virtual characters may have different skills. For instance, the second team-member virtual character in the teammate list 303 has "stealth" and "transfer" skills, and a fourth team-member virtual character has "bombing" and "exploding" skills. In some embodiments, the skill icons of the skills respectively possessed by at least two team-member virtual characters are displayed on the game interface corresponding to the first client, and the team commander may mark at least two skills. In one embodiment, the team commander may choose to mark different skills of the same team-member virtual character, or may choose to mark the skills of different team-member virtual characters. The team commander may be the captain or the team member having the command permission. The captain is used as an example for description in the embodiments of this application.

Operation 240: Display, in response to a marking operation sequentially performed on at least two skills by a user of the terminal device, marking serial numbers respectively corresponding to the at least two skills according to a marking order.

Each marking serial number is configured for indicating a suggested casting order of a current skill among the at least two skills.

In some embodiments, the at least two skills include at least two skills corresponding to different team-member virtual characters, or at least two skills corresponding to the captain virtual character and the team-member virtual characters.

In some embodiments, the marking serial numbers respectively corresponding to the at least two skills are displayed according to the marking order in response to the marking operation sequentially performed on the at least two skills. In one embodiment, the marking operation on the at least two skills includes, but is not limited to, a clicking/tapping operation, a long-press operation, a sliding operation, a touching operation, a key operation, a gesture operation, and a free combination of at least two of the foregoing operations.

For instance, an example in which the marking operation is sequentially performed on two skills is used. In an implementation, sequentially performing the marking operation on the two skills includes: sequentially performing a clicking/tapping operation on the first skill and the second skill, or performing sequential connection through a sliding operation of sliding from the skill icon corresponding to the first skill to the skill icon corresponding to the second skill.

In some embodiments, the captain sequentially marks at least two skills possessed by the team-member virtual characters displayed on the game interface. The at least two skills are switched to the marked state after being marked. The marked state is a state presented after the skill is selected by the captain. In some embodiments, after a team member obtains the command permission, the team member having the command permission may select to perform the marking operation on the skills possessed by other team-member virtual characters.

An example in which the captain performs the marking operation is used for description in the embodiments of this application.

In some embodiments, a marked skill usually has a visual change or mark to indicate that the skill has been selected. For example, when a skill is in the marked state, the visual salience of the skill icon corresponding to the skill is higher than that of a non-marked skill. In one embodiment, the color of the frame of the skill icon corresponding to the marked skill changes: the skill icon corresponding to the marked skill may be distinguished from other unmarked skills by using a frame having a color. Alternatively, the skill icon corresponding to the marked skill is highlighted: the skill icon corresponding to the marked skill may present a flickering effect or be highlighted. Alternatively, the skill icon corresponding to the marked skill is tagged with a mark symbol: a small mark symbol such as a tick or a star is added to the marked skill icon to indicate that the skill has been selected. The foregoing is merely an exemplary description, and displaying of a skill after the skill is marked is not limited in this application.

In some embodiments, after at least two skills are marked, their respective marking serial numbers are displayed in local regions of the skill icons or at peripheral sides of the skill icons according to the marking order. The marking serial number is configured for indicating a suggested casting order of a current skill among the at least two skills. In one embodiment, the marking serial number is also configured for indicating a priority of the marked skill.

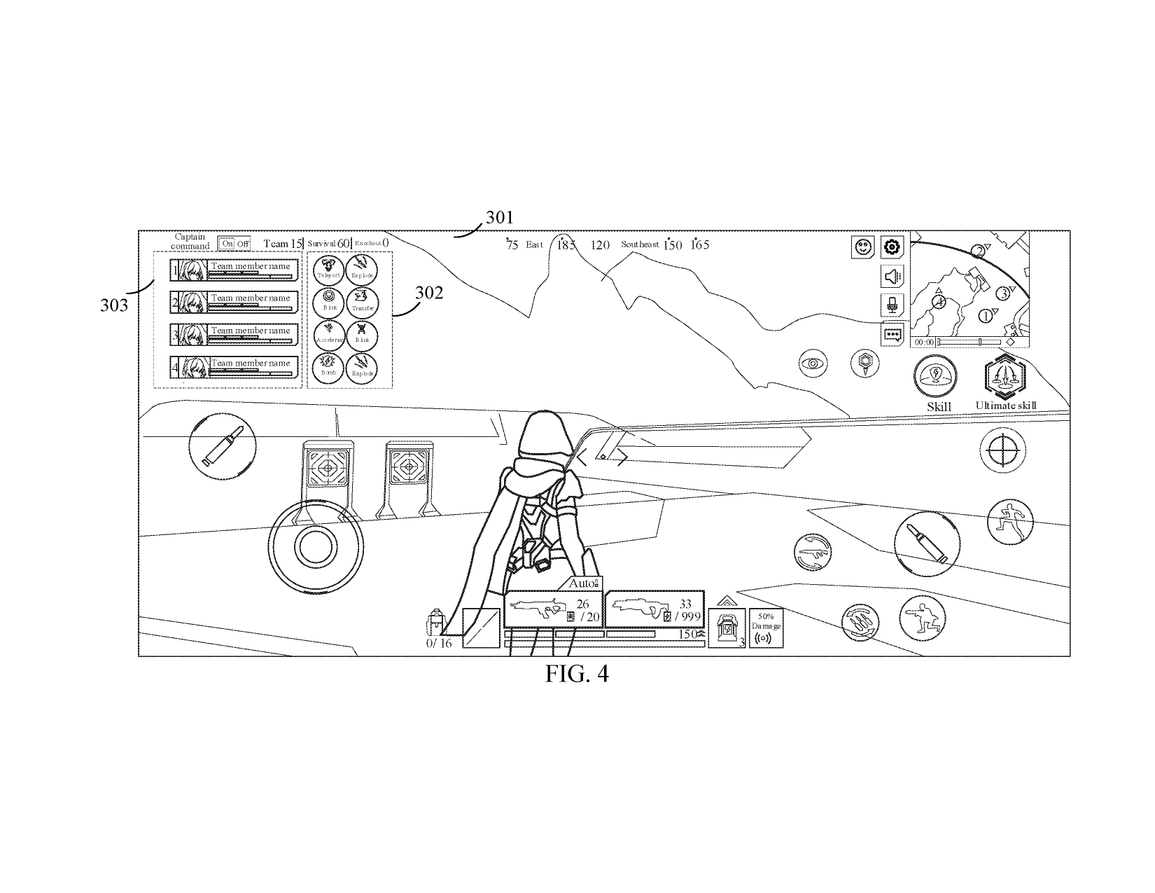

As shown in FIG. 5, the captain separately marks two skills on the game interface 401. In response to the marking operation sequentially performed by the captain on the two skills, the marking serial numbers are displayed in the local regions of the skill icon 402 corresponding to the "transfer" skill and the skill icon 403 corresponding to the "exploding" skill. Taking as an example that the captain first marks the "transfer" skill and then marks the "exploding" skill, the marking serial number corresponding to the "transfer" skill is 1, and the marking serial number corresponding to the "exploding" skill is 2. The marking serial numbers indicate the casting order of the respective skills. The skill with the marking serial number 1 is cast in an order before the skill with the marking serial number 2.

Operation 260: Sequentially trigger, according to the marking serial numbers, transmission of casting prompt information to a team member corresponding to each skill among the at least two skills.

The casting prompt information is configured for instructing the team member to cast the skill. For example, the casting prompt information is prompt information for a team member to perform a virtual action of casting a skill, and is configured for prompting the team member that the captain or a team member having the command permission in the team recommends casting the skill.

In some embodiments, after the captain marks at least two skills, the first client saves the marking operation, and transmits data to the server. The server returns data corresponding to the operation of the first client to a second client. Specifically, the server triggers, according to the order of the marking serial numbers, the transmission of the casting prompt information to the team member corresponding to each marked skill, to instruct the team member to cast the skill.

For example, the captain marks three skills in a game, and the three skills respectively correspond to three different team members. The marking serial number of the first skill is 1, the marking serial number of the second skill is 2, and the marking serial number of the third skill is 3. The server would sequentially transmit the casting prompt information to the three team members to ensure that the three team members cast corresponding skills at correct occasions.

In some embodiments, the casting prompt information may be conveyed in different manners. For example, the casting prompt information may be presented visually: a preset sign, icon, or animation is displayed on the game interface of a team member to prompt the team member to cast a skill. The visual indication may distinguish between the casting prompt information corresponding to different skills by using different colors, shapes, or dynamic effects. Alternatively, the casting prompt information may be presented as audio: a team member is notified, by using a preset sound effect or voice prompt, when to cast a skill. The audio prompt may correspond to different sounds or voices to distinguish between the casting prompt information corresponding to different skills. Alternatively, the casting prompt information may be presented as text information: the text information is displayed on the game interface of a team member to notify the team member of when to cast a skill. The text information may indicate, in a simple and clear manner, the order or the time of casting skills. The foregoing are merely exemplary examples of the casting prompt information, and the casting prompt information is not limited in this application.

In an exemplary implementation, the casting prompt information is configured for changing the cast state of a skill. For example, the second client that receives the casting prompt information switches the skill to a to-be-cast state in response to receiving the casting prompt information, displays a casting location of the skill by displaying a skill indicator of the skill in the virtual environment, and prompts the team member to cast the skill. Still further, the skill in the to-be-cast state corresponds to a timer. When the timer reaches a timing threshold, the skill is cast in the virtual environment. For example, the timer stops timing in response to a cancel operation performed by the team member. The timer corresponding to the skill provides a function entry for automatically casting the skill and the cancel operation performed by the team member provides a permission to cancel skill casting, enabling the team member and the captain or the team member having the command permission who transmits the casting prompt information in the team to jointly perform skill casting. Thus, a new skill casting manner is provided. The communication and command process between the captain and the team members is simplified. The captain or the team member having the command permission in the team is allowed to cast the skill of another team member. A new human-computer manner is provided. The gaming experience of the captain and the team members is enhanced.

In conclusion, according to the method provided by the embodiments of this application, the marking serial numbers respectively corresponding to at least two skills are displayed according to the marking order in response to the marking operation for the at least two skills, each marking serial number being configured for indicating the suggested casting order of the current skill among the at least two skills. The transmission of the casting prompt information to the team member corresponding to each skill among the at least two skills is sequentially triggered according to the marking serial numbers, the casting prompt information being configured for instructing the team member to cast the skill. The skills of the team members in the team are marked by the captain, and the order of casting the skills by the team members is instructed. The communication and command process between the captain and the team members is simplified, thereby reducing information transmission errors and time delays and enhancing the gaming experience of the captain and the team members.

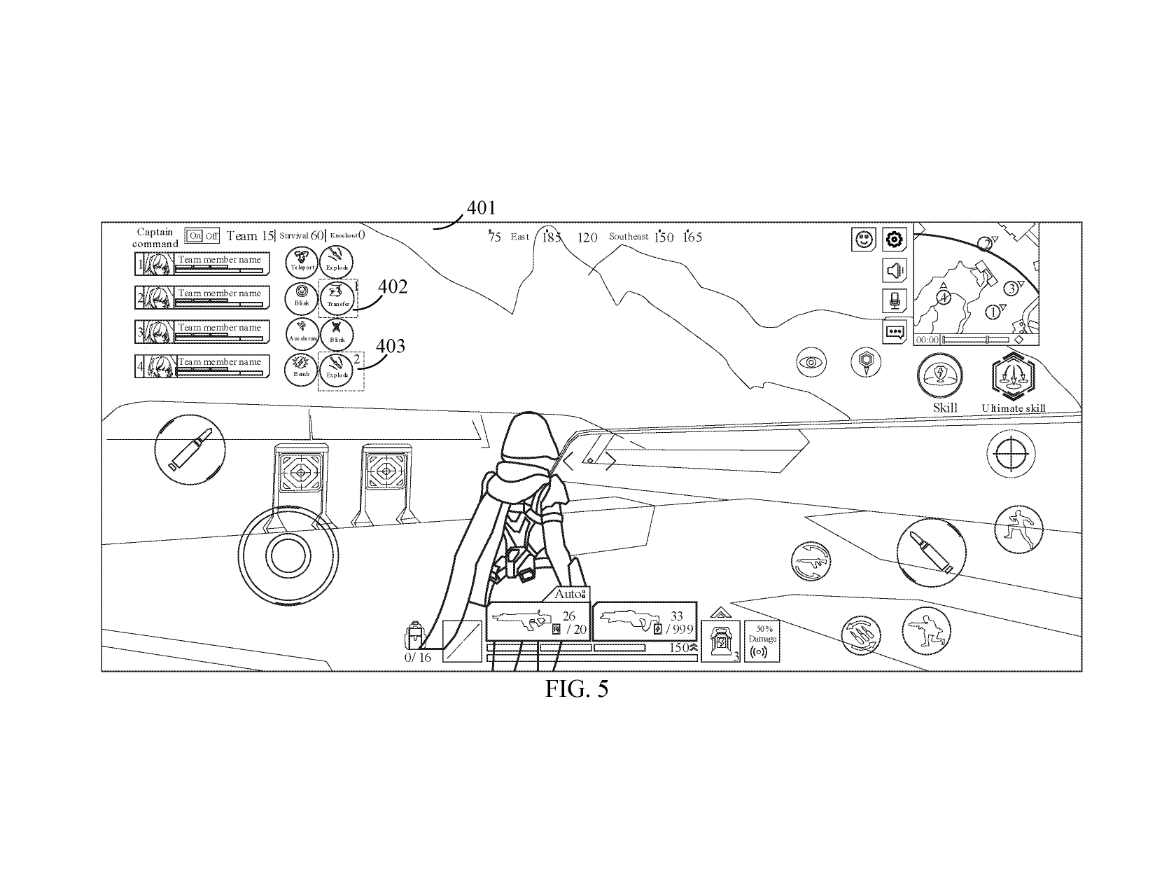

In some embodiments, a command control is further displayed on the game interface of the captain. In response to the operation of triggering the command control, the skill icons of the skills respectively possessed by at least two team-member virtual characters are displayed. As shown in FIG. 6, the method further includes operation 210.

Operation 210: Display a command control, the command control being configured to enable or disable a command permission.

The command control includes an on state and an off state. The command control is configured for a team commander to enable or disable the command permission. In one embodiment, the team commander may be the captain of a team. Alternatively, the team commander is a team member having the command permission.

In some embodiments, the team commander is determined at the beginning of a game. The manner of determining the team commander may be selected according to a game design requirement. In one embodiment, the team commander may be the captain by default. This is a simple and direct setting manner. Alternatively, the team commander is a team member designated by the captain. The captain may designate a team member in the team as the team commander. Alternatively, a team member of a virtual character of a specified type acts as the team commander. A game may automatically determine a team member suitable for acting as the team commander according to characteristics and responsibilities of different virtual characters in a team. For example, a mage may be better at outputting damage, while a support may be better at supporting teammates, and a team member most suitable for acting as the team commander may be selected according to requirements of the team in different cases. Alternatively, the team commander is determined by means of voting. Before the battle starts, team members may select the team commander by means of voting. The team commander may be determined according to a criterion of obtaining the maximum number of tickets. In one embodiment, the team commander may be changed and determined during a game process. For example, the team commander is determined according to the highest current economy, where the highest current economy may refer to the most current gold coins, resources, wealth, or the like. Alternatively, the team commander is determined according to the maximum number of enemy virtual character currently killed. Alternatively, the team commander is determined according to the highest current kill/death/assist (KDA). The foregoing are merely exemplary examples of determining the team commander, and the manner of determining the team commander is not limited in this application. An example in which the team commander is the captain is used for description in the embodiments of this application.

In some embodiments, the command control is an interactive interface element, and is usually presented in a text form, a switch button form, or other interaction forms. In one embodiment, by clicking/tapping on or switching the command control, the captain may switch the on state and the off state of the command mode in real time.

In one embodiment, when the captain provides the command control to enable the command permission, the server loads the skill icons and skill states of the skills possessed by the team-member virtual characters that are currently in the survival state, and feeds back results to the first client. The captain may sequentially perform the marking operation on at least two skills displayed on the game interface. When the captain disables the command permission, the captain is limited to the character of the common team member, no longer has the command right, and cannot perform the marking operation on the skills possessed by the team-member virtual characters.

In one embodiment, the command control is composed of a text and a switch button. The visual salience of the command control when in the on state is higher than that of the command control when in the off state.

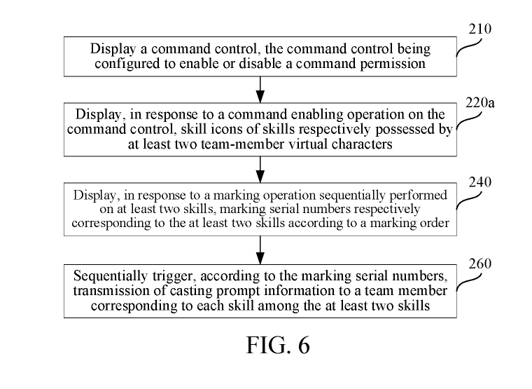

As shown in FIG. 7, the captain allows the command control 502 to be displayed on the game interface 501. The command control 502 is composed of a text and a switch button. An initial default state of the command control 502 is the off state. After the captain clicks/taps on the command control 502, the command control 502 is switched from the off state to the on state, allowing the captain to enable the command permission.

Operation 220 may be replaced with operation 220a.

Operation 220a: Display, in response to a command enabling operation on the command control, the skill icons of the skills respectively possessed by the at least two team-member virtual characters.

In some embodiments, the skill icons of the skills respectively possessed by the at least two team-member virtual characters are displayed in response to the command enabling operation on the command control. In one embodiment, the command enabling operation on the command control includes, but is not limited to, a clicking/tapping operation, a long-press operation, a sliding operation, a touching operation, a key operation, a gesture operation, and a free combination of at least two of the foregoing operations.

In some embodiments, the captain triggers the command enabling operation on the command control. The skill icons of the skills respectively possessed by at least two team-member virtual characters are displayed on the game interface corresponding to the captain. In one embodiment, the at least two team-member virtual characters are virtual characters that are in the survival state.

For the related content of the skill icons, please refer to the related content of operation 220. Details are not repeated here.

In conclusion, according to the method provided by the embodiments of this application, the command control is displayed on the game interface of the captain. The command control is configured to enable or disable the command permission. The captain may quickly enable the command permission via the command control. The skill icons of the skills respectively possessed by at least two team-member virtual characters are displayed in response to the command enabling operation on the command control. By displaying the skill icons of the team-member virtual characters, the captain may more clearly know the skills possessed by the team-member virtual characters and perform marking according to the displayed skills. This manner reduces time required for communication between the captain and the team members, and improves fighting efficiency.

In some embodiments, the skill icons of the skills respectively possessed by at least two team-member virtual characters are displayed, where each skill includes two states: ready (state) and cooldown (state).

Ready (state):

When a skill is in the ready state, the skill is ready and may be used or cast immediately. The captain or the team members may directly trigger the skill without waiting for additional time.

Cooldown (state):

When a skill is in the cooldown state, the skill has been used, and can be used again after a cooldown time. In the cooldown state, the captain or the team members cannot trigger the skill, and need to wait for the end of the cooldown time to reuse or cast the skill.

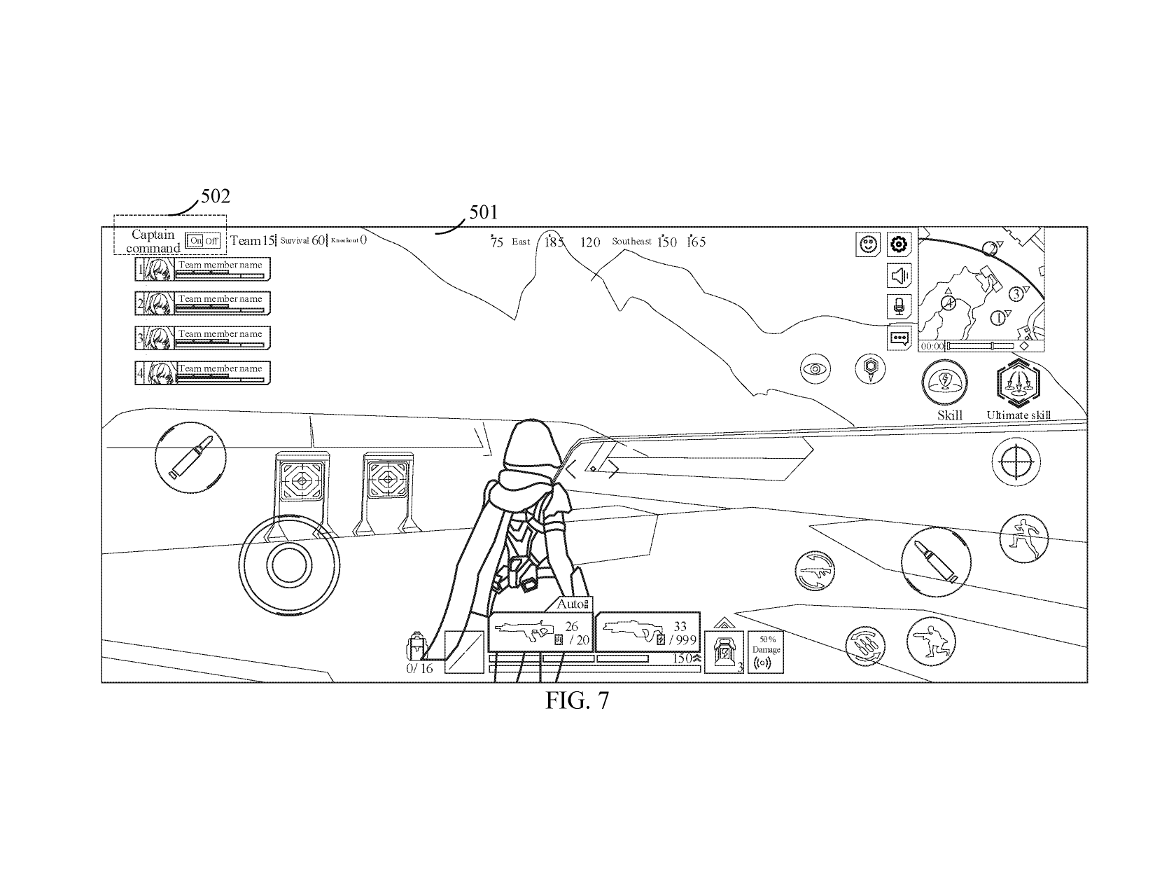

FIG. 8 illustrates a flowchart of a method for casting a skill provided by an exemplary embodiment of this application. Operation 240 may be replaced with operation 240a.

For a skill in the ready state:

Operation 240a: Display, in response to the marking operation sequentially performed on at least two skills and skill states of the at least two skills being ready, the marking serial numbers respectively corresponding to the at least two skills according to the marking order.

The skill state refers to the current availability or capability of being cast of a skill. In one embodiment, the skill state includes the ready state and the cooldown state.

In some embodiments, the captain may sequentially mark a plurality of skills in the ready state, and switch the plurality of skills to the marked state. Meanwhile, the current marking serial numbers are displayed in the local regions of or at the peripheral sides (e.g., top right corners) of the skill icons corresponding to the plurality of skills. The marking serial number is updated to n+1, n being the number of marked skills still in the marking sequence before the current marking.

An example in which the captain sequentially marks two skills is used.

In one embodiment, the captain sequentially marks two skills in the ready state. The captain first selects the first skill in the ready state, and performs the marking operation on the first skill, including performing at least one of a clicking/tapping operation, a long-press operation, a sliding operation, a touching operation, a key operation, and a gesture operation on the skill icon corresponding to the first skill. In one embodiment, after the marking operation is performed on the first skill, the first skill is switched from the ready state to the marked state. Meanwhile, the corresponding marking serial number is displayed in the local region of or at the peripheral side of the skill icon corresponding to the first skill. For example, the marking serial number of the first skill is 1. After the first skill is successfully marked, the captain selects the second skill in the ready state again and performs the marking operation on the second skill, including performing at least one of a clicking/tapping operation, a long-press operation, a sliding operation, a touching operation, a key operation, and a gesture operation on the skill icon corresponding to the second skill. In one embodiment, after the marking operation is performed on the second skill, the second skill is switched from the ready state to the marked state. Meanwhile, the corresponding marking serial number is displayed in the local region of or at the peripheral side of the skill icon corresponding to the second skill. For example, the marking serial number of the second skill is 2. The marking serial number is configured for indicating the suggested casting order of the current skill among at least two skills. For example, the first skill with the marking serial number 1 is cast in an order before the second skill with the marking serial number 2.

In some embodiments, at least two skills that are ready are selected and marked sequentially by the captain, and the casting order of the at least two skills is specified. Such an operation helps the team to orderly cast skills during a fight, thereby improving the fighting efficiency and the tactical flexibility.

For a skill in the cooldown state:

Display, in response to a triggering operation on a first skill and the state of the first skill being cooldown, prompt information indicating that the first skill is being cooled down.

The first skill is a skill in the cooldown state. The skill in the cooldown state can be used again after a preset time.

In some embodiments, when the first skill is in the cooldown state, a cooldown progress circle is displayed on the skill icon corresponding to the first skill to indicate the cooldown progress of the first skill. In one embodiment, the cooldown progress circle displays a ratio of a current remaining time to a total cooldown time to visually show the first skill cooldown progress. For example, if the total cooldown time of the first skill is 10 seconds and 5 seconds have passed, the cooldown progress circle may display half of the progress, or display a percentage, such as 50%, of the ratio of the current remaining time to the total cooldown time.

In some embodiments, in response to the marking operation on the first skill, the triggering operation by the captain for the first skill includes at least one of a clicking/tapping operation, a long-press operation, a sliding operation, a touching operation, a key operation, and a gesture operation on the skill icon corresponding to the first skill. In one embodiment, when the state of the first skill is cooldown, the prompt information indicating that the first skill is being cooled down is displayed on the game interface of the captain in response to the marking operation for the first skill.

In some embodiments, the prompt information is configured for informing the captain that the first skill is currently in the cooldown state. In one embodiment, the prompt information may be presented in the form of text, an icon, a progress bar, or the like. In one embodiment, the prompt information may be displayed in a partial region on the game interface to prompt the remaining time for cooldown of the first skill. In one embodiment, the prompt information is presented in the form of text, such as "Skill is being cooled down", and "Skill can be used after X seconds". Alternatively, the prompt information is presented in the form of a progress bar, and the length and the color of the progress bar usually correspondingly change as the remaining cooldown time changes, so that the captain more accurately determines the cooldown progress of the first skill.

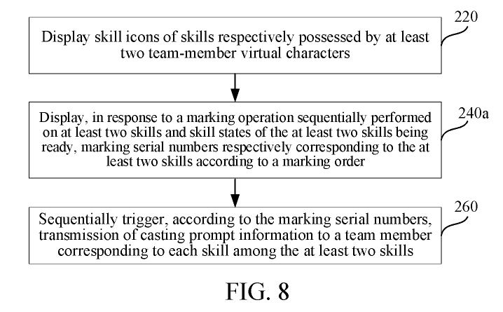

As shown in FIG. 9, the first skill 602 is a "transfer" skill. The first skill 602 is in the cooldown state. In response to the triggering operation for the "transfer" skill, the prompt information 603 is displayed on the game interface 601 of the captain. The prompt information 603 is "Skill is being cooled down ...". The prompt information 603 is configured for prompting that the first skill 602 cannot be marked within a preset time (a cooldown time).

In conclusion, according to the method provided by the embodiments of this application, the skill states are classified as the ready state and the cooldown state. When skills are in the ready state, the marking serial numbers respectively corresponding to at least two skills are displayed according to the marking order in response to the marking operation sequentially performed on at least two skills and the skill states of the at least two skills being ready. When the skill state is the cooldown state, the prompt information indicating that the first skill is being cooled down is displayed in response to the triggering operation on the first skill and the state of the first skill being cooldown. With the marking operation and the display of the skill states, the captain can clearly know the state of each skill. With the clear marking serial numbers, operation mistakes of team members caused by confused skill states can be reduced, and game fluency can be improved.

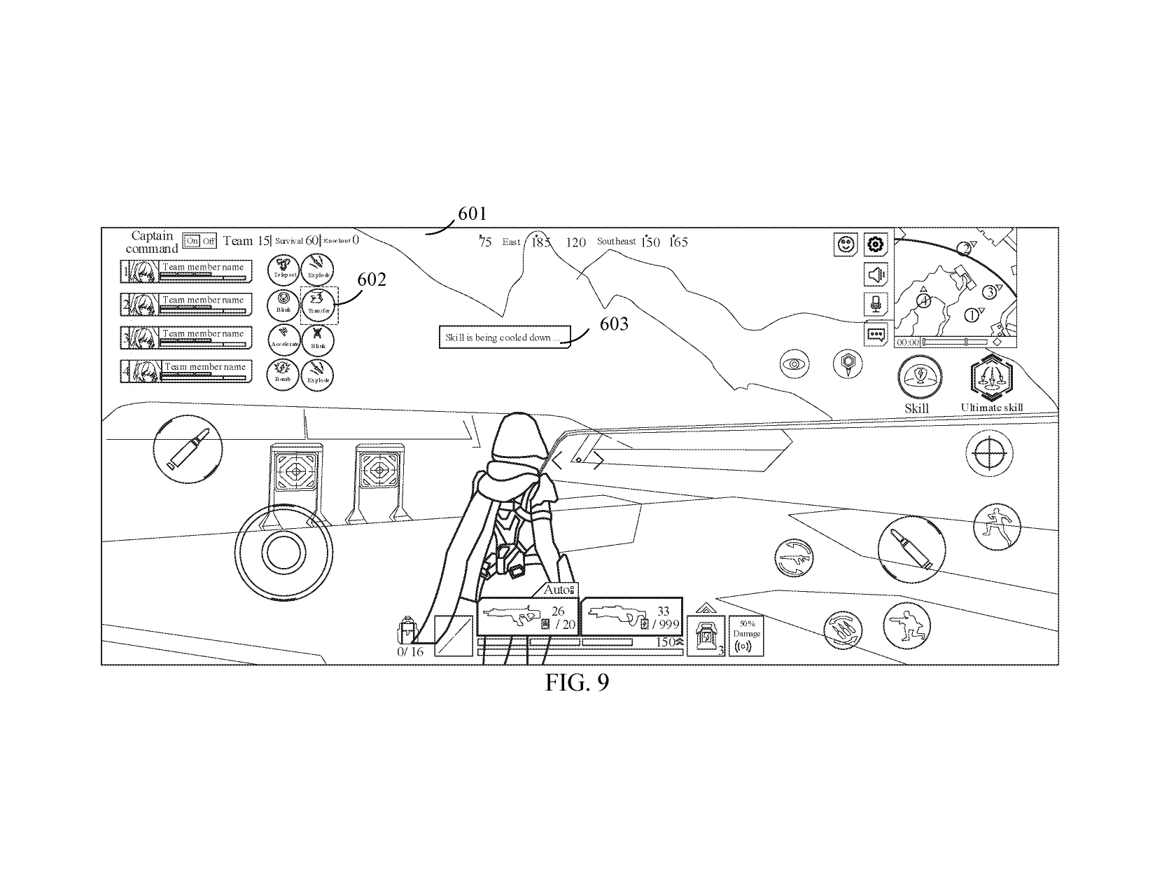

FIG. 10 illustrates a flowchart of a method for casting a skill provided by an exemplary embodiment of this application. Operation 260 may be replaced with operation 260a and operation 260b.

Operation 260a: Trigger the transmission of the casting prompt information to a team member corresponding to a skill with a first marking serial number.

The casting prompt information is configured for instructing the team member to cast the skill with the first marking serial number.

In one embodiment, the captain may continuously mark a plurality of skills in the ready state, and switch the plurality of skills to the marked state. Meanwhile, the marking serial numbers corresponding to the current skills are displayed in the local regions of or at the peripheral sides of the skill icons corresponding to the plurality of skills. The marking serial number is updated to n+1, n being the number of marked skills still in the marking sequence before the current marking. In one embodiment, the marking serial number may indicate the priority of the currently marked skill among the marked skills. By setting the marking serial numbers, the priority of each marked skill in the casting order may be determined, thereby ensuring that the team casts skills according to a preset order.

For example, after three skills in the ready state are marked, the priority of the skill with the first marking serial number is 1, while the priority of the skill with the second marking serial number is 2, and the priority of the skill with the third marking serial number is 3. A skill with a higher marking serial number priority is recommended to be cast preferentially over a skill with a lower marking serial number priority. For example, the skill with the first marking serial number is recommended to be cast preferentially over the skill with the second marking serial number and the skill with the third marking serial number, and the skill with the second marking serial number is recommended to be cast preferentially over the skill with the third marking serial number.

In some embodiments, when the captain triggers the skill with the first marking serial number, the client of the captain detects the triggering operation. The client corresponding to the captain transmits a trigger request for the skill with the first marking serial number to the server. The trigger request includes related information of the skill with the first marking serial number, such as an identifier of the skill with the first marking serial number and the team member corresponding to the skill with the first marking serial number. After receiving the trigger request from the client of the captain, the server performs corresponding processing, determines the team member corresponding to the skill with the first marking serial number, and transmits the casting prompt information to the team member. In some embodiments, the captain may perform the marking operation on the skill in two different manners and trigger the casting prompt information. For instance, an example in which the captain performs the marking operation on two skills is used. In one embodiment, the captain triggers the two skills after continuously performing the marking operation on the two skills: the captain may first perform the marking operation on the first skill, then perform the marking operation on the second skill, and finally trigger the casting prompt information for the two skills according to the marking serial numbers. Alternatively, the captain performs the marking operation on the two skills stepwise and triggers the two skills: the captain may choose to first perform the marking operation on the first skill and trigger the casting prompt information therefor, and then to perform the marking operation on the second skill and trigger the casting prompt information therefor. The above-mentioned skills on which the marking operation is performed are all skills in the ready state, thereby ensuring that the skills may be cast immediately.

Operation 260b: Decrease, after the skill with the first marking serial number is cast, each of the marking serial numbers respectively corresponding to remaining skills among the at least two skills by one, and then perform the previous operation again.

The remaining skills are skills that have not been cast among the at least two skills. In some embodiments, once the skill with the first marking serial number is cast, the marking serial numbers of the remaining skills are each decreased by one, and then the previous operation is performed again. Each time a skill with a marking serial number is cast, the marking serial numbers of the remaining skills are correspondingly updated. For example, when the captain continuously marks a plurality of skills in the ready state, the first skill has the first marking serial number, and the second skill and the third skill have the second and third marking serial numbers, respectively. The captain triggers the casting prompt information for the first skill. After the first skill is cast, the marking serial numbers of the second skill and the third skill are each decreased by one. To be specific, the marking serial number of the second skill is changed to the first marking serial number, while the marking serial number of the third skill is changed to the second marking serial number. In this case, the captain chooses to continuously trigger the casting prompt information for the second skill. After the second skill is cast, the marking serial number of the third skill is decreased by one. To be specific, the marking serial number of the third skill is changed to the first marking serial number. In one embodiment, if there are still other skills that need to be cast, the marking serial numbers of these skills need to be each decreased again. To be specific, the marking serial number of an nth skill with the marking serial number n is changed to n-1. The foregoing operations are repeated until all the skills are cast.

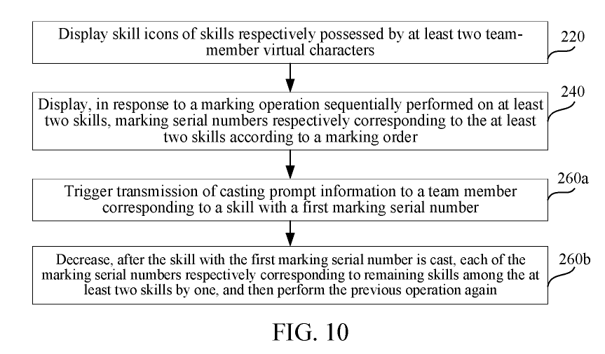

For example, referring to FIG. 11, as shown in FIG. 11 (1), the captain separately marks two skills on the game interface 701. The first skill 702 corresponds to a "transfer" skill, and the second skill 703 corresponds to an "exploding" skill. The marking serial number of the "transfer" skill is 1, while the marking serial number of the "exploding" skill is 2. After the "transfer" skill with the marking serial number 1 is cast, the marking serial number corresponding to the "transfer" skill disappears, and the marking serial number corresponding to the "exploding" skill is changed to 1, as shown in FIG. 11 (2). In some embodiments, if there is a target skill that is not cast in advance according to the marking order, the target skill is deleted from the at least two skills, and a marking serial number of another skill that is cast behind the target skill among the at least two skills is decreased by one. The target skill refers to a skill that is not cast according to the marking serial number. If the target skill is cast in advance in the queue, a background system corresponding to the first client removes the target skill from the at least two skills. In this way, it can be ensured that the target skill is not repeatedly cast or interferes with subsequent skill casting. By deleting the target skill cast in advance and adjusting the marking serial numbers of other skills, a correct skill casting order can be ensured.

In some embodiments, the at least two skills include at least two skills corresponding to different team-member virtual characters, or at least two skills corresponding to the captain virtual character and the team-member virtual characters. At least two skills in a game are classified such that the skills correspond to different team-member virtual characters or the captain virtual character. A proper skill combination may be selected according to a specific situation. This manner provides more tactical choices and combinations for players.

For example, when the captain continuously marks a plurality of skills in the ready state, after the third skill with the marking serial number 3 is cast, the target skill is the third skill, and the third skill is deleted from to-be-cast skills. The marking serial numbers of skills with marking serial numbers less than 3 are each decreased by one, and the marking serial numbers of skills with marking serial numbers greater than 3 remain unchanged. For example, the marking serial numbers of the first skill with the marking serial number 1 and the second skill with the marking serial number 2 remain unchanged, while the marking serial number of the fourth skill with the marking serial number 4 is changed to 3 and the marking serial number of the nth skill with the marking serial number n is changed to n-1.

In an implementation, after the skill with the first marking serial number is cast, on the game interface of the captain, the marking serial numbers respectively corresponding to the remaining skills remain unchanged, and the visual salience of the skill icon corresponding to the skill with the first marking serial number is lower than that of the skill icons corresponding to the remaining skills. For example, the skill with the first marking serial number is cast and the skill icon corresponding to the skill with the first marking serial number becomes green, indicating that the skill has been cast completely. Alternatively, an icon (e.g., a check icon) is displayed in the local region of the skill icon corresponding to the skill with the first marking serial number, indicating that the skill has been cast completely.

In conclusion, according to the method provided by the embodiments of this application, in a team cooperation process, the captain may trigger a skill to instruct a team member to correspondingly cast the skill with the marking serial number. After receiving the triggering signal from the captain, the server transmits the casting prompt information to the corresponding team member according to the set marking serial number and a correspondence. This process can ensure that the casting order and priority of a skill are properly controlled, thereby implementing a more efficient, harmonious, and strategic fighting manner.

For a common team member (having no command permission) in a team:

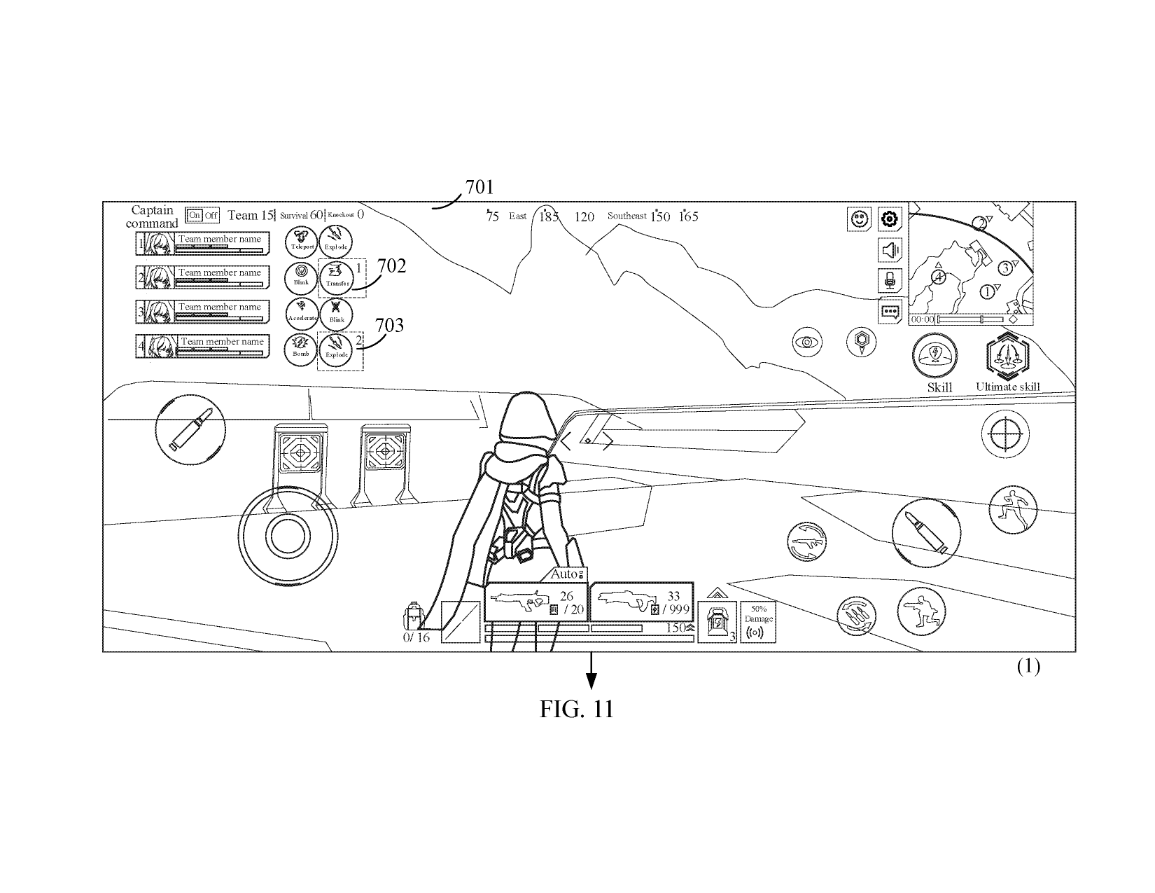

FIG. 12 illustrates a flowchart of a method for casting a skill provided by an exemplary embodiment of this application. The method is performed by a second client. An example in which the method is applied to the terminal device 130 shown in FIG. 1 is used for description. The method includes operation 320, operation 340, and operation 360 as follows.

Operation 320: Display a skill icon of a skill possessed by a team-member virtual character.

In some embodiments, a second client supporting a virtual environment runs on the terminal device. A game interface of the second client displays the skill icon of the skill possessed by the team-member virtual character in the virtual environment.

The team-member virtual character is a virtual character controlled by a team member in a team. In a game, team-member virtual characters may form a team to collaboratively complete tasks. In one embodiment, the team-member virtual characters may be virtual characters of different types, and different team-member virtual characters are respectively good at different skills and fighting manners.

In some embodiments, the skills possessed by the team-member virtual characters may be displayed via skill icons. The skill icons refer to icons or buttons for representing different skills on the game interface. The skill icons are configured to help the team members quickly recognize and select corresponding skills for use. The skill icons may be in various shapes and colors, and are usually associated with characteristics or effects of the corresponding skills. For example, an "exploding" skill may have an exploding icon, a "bombing" skill may have a bombing icon, and an "accelerating" skill may have a running icon. In one embodiment, the skill icon further includes a skill name corresponding to the skill.

In some embodiments, different team-member virtual characters may possess the same or different skills, and the same team-member virtual character may have the same or different skills. This is not limited in this application.

Operation 340: Display casting prompt information on the skill.

The casting prompt information is configured for indicating that a team commander recommends casting the skill. In one embodiment, the team commander may be the captain of a team. Alternatively, the team commander is a team member having the command permission. An example in which the team commander is the captain is used for description in the embodiments of this application. In some embodiments, the casting prompt information is transmitted to a team member corresponding to each skill among at least two skills sequentially triggered according to marking serial numbers, where the marking serial numbers are obtained by sequentially marking the at least two skills by the team commander, and each marking serial number is configured for indicating a suggested casting order of a current skill among the at least two skills. Tactical coordination between team members can be enhanced by marking skills by the team commander and triggering the skills to be cast sequentially according to the marking serial numbers. The team commander may determine the skill casting order according to a battle situation change and the states of the team members, thus better dealing with the battle situation.

In some embodiments, the casting prompt information is displayed at a corresponding skill location on the game interface of the team member corresponding to the skill with the first marking serial number. In some embodiments, the casting prompt information may be conveyed in different manners. For example, the casting prompt information may be presented visually: a preset sign, icon, or animation is displayed on the game interface of a team member to prompt the team member to cast a skill. The visual indication may distinguish between the casting prompt information corresponding to different skills by using different colors, shapes, or dynamic effects. Alternatively, the casting prompt information may be presented as audio: a team member is notified, by using a preset sound effect or voice prompt, when to cast a skill. The audio prompt may correspond to different sounds or voices to distinguish between the casting prompt information corresponding to different skills. Alternatively, the casting prompt information may be presented as text information: the text information is displayed on the game interface of a team member to notify the team member of when to cast a skill. The text information may indicate, in a simple and clear manner, the order or the time of casting skills. In one embodiment, the casting prompt information may be a combination of the foregoing indication manners. The foregoing are merely exemplary examples of the casting prompt information, and the casting prompt information is not limited in this application.

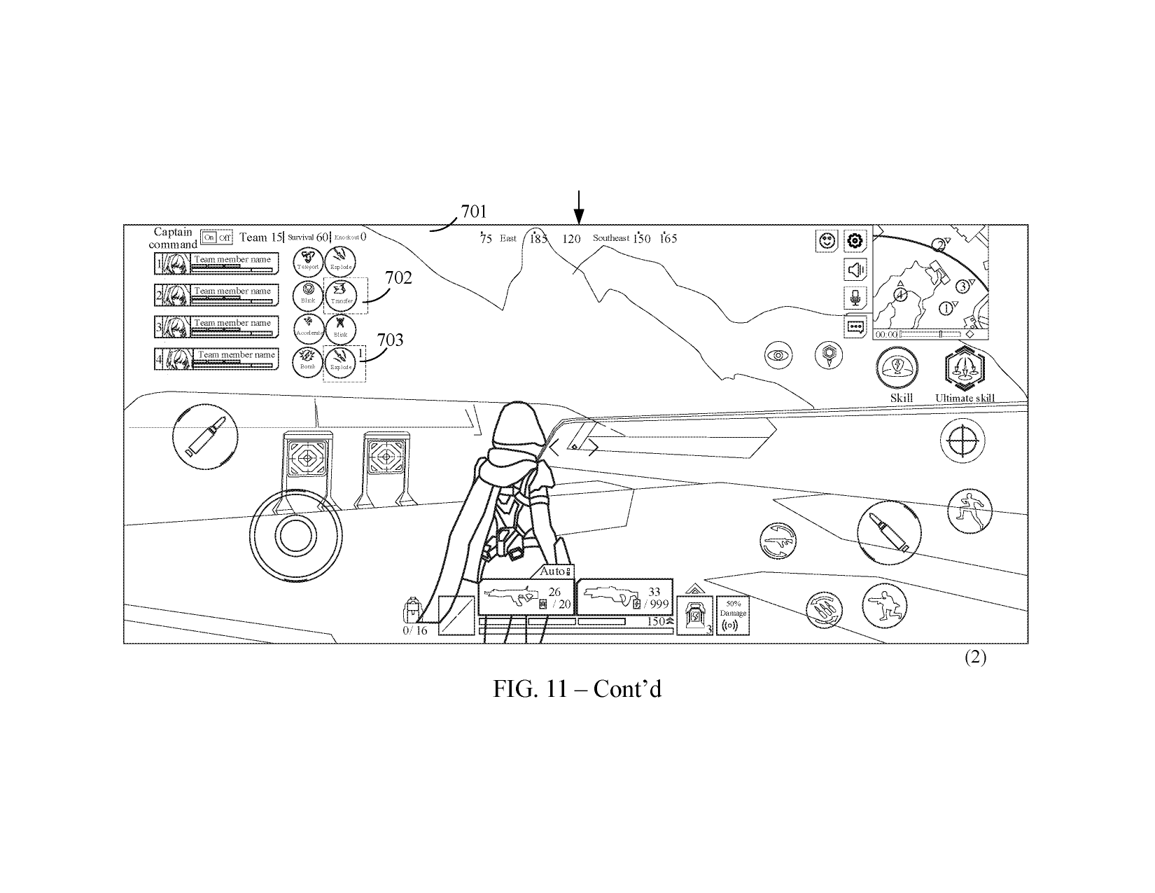

In some embodiments, the casting prompt information includes at least one of: an avatar of the team commander; and text prompt information configured for recommending casting the skill. In one embodiment, the avatar of the team commander is displayed at the top of a skill key, so that the team members can intuitively learn that the current casting prompt information is from the team commander, thereby improving the credibility and execution efficiency of the casting prompt information. A text prompt is displayed at the top of the skill key to indicate a skill that the current team commander recommends casting, so that the team members can clearly know an operation that needs to be performed. As shown in FIG. 13, a skill casting prompt 803 is displayed above the skill icon 802 on the game interface 801 of a team member. The skill casting prompt 803 includes the avatar of the team commander and the text prompt information configured for recommending casting the skill. The text prompt information "Captain recommends using" or "Captain recommends casting the skill now" is displayed beside the avatar of the team commander. In one embodiment, the team member may perform a corresponding operation according to the skill casting prompt 803.

Operation 360: Cast the skill in response to a triggering operation on the skill icon.

In some embodiments, the skill of the team-member virtual character is cast according to casting prompt information transmitted by the captain in response to the triggering operation performed by the team member on the skill icon. In one embodiment, the triggering operation on the skill icon includes, but is not limited to, a clicking/tapping operation, a long-press operation, a sliding operation, a touching operation, a key operation, a gesture operation, and a free combination of at least two of the foregoing operations.

In some embodiments, the captain selects and marks a skill that needs to be cast in a game, and the server transmits the casting prompt information to the team member corresponding to the skill with the marking serial number 1. The casting prompt information transmitted by the captain will be displayed on the game interface of the team member. The team member casts the skill by triggering the skill icon. After detecting the triggering operation of the team member, a background system of the client of the team member casts the skill of the team-member virtual character.

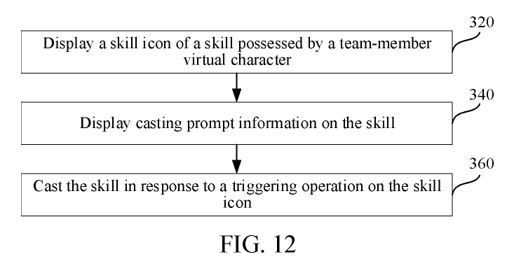

In one embodiment, after the team member casts the skill according to the skill casting prompt, on the game interface of the team member, the skill casting prompt disappears, indicating that the skill has been cast. Moreover, the skill is switched to the cooldown state, and a cooldown progress of the skill is displayed on the skill icon corresponding to the skill. With reference to FIG. 14, after the team member casts the skill according to the skill casting prompt, the skill icon 902 is displayed on the game interface 901 of the team member. The skill icon 902 represents the cooldown state after the skill is cast. The skill icon 902 displays the cooldown progress of the skill, for example, displays that the ratio of the current remaining time to the total cooldown time is 98%.

In some embodiments, after the corresponding skill with the first marking serial number is cast, a marking serial number corresponding to the skill will disappear from the sequence of marked skills. The marking serial number corresponding to the skill with the second marking serial number is changed to the first marking serial number, while the marking serial number corresponding to the skill with the third marking serial number is changed to the second marking serial number, and the marking serial number corresponding to the skill with the nth marking serial number is changed to an (n-1)-th marking serial number.

In conclusion, according to the method provided by the embodiments of this application, the skill icon of the skill possessed by the team-member virtual character is displayed. The avatar of the team commander and the text prompt information configured for recommending casting the skill are displayed at the top of the skill icon. The skill is cast in response to the triggering operation on the skill icon. The team member may intuitively and rapidly cast the skill according to a skill casting instruction. Thus, the operation complexity is reduced, and the gaming experience of the team member is enhanced.

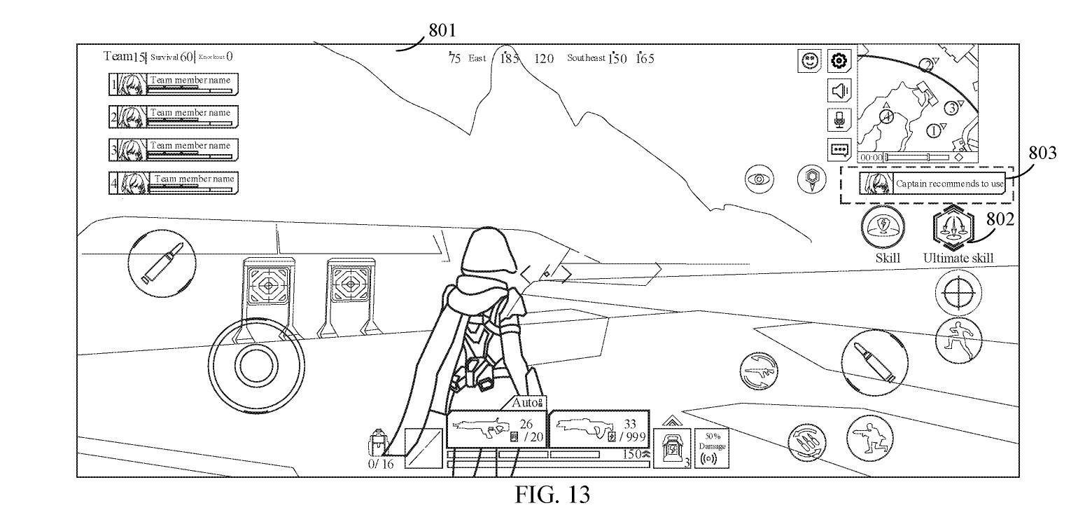

FIG. 15 illustrates a flowchart of a method for casting a skill provided by an exemplary embodiment of this application. The method is performed by a first terminal and a second terminal, and includes at least one of the following operations.

Operation 1: Start.

Operation 2: Determine whether a player is the captain. After the player enters a game, whether the current player is the captain of a team is determined. If the current player is the captain, operation 3 is performed. If the current player is a team member, operation 11 is performed.

Operation 3: Display a command control. If the current player is the captain of the team, the command control is displayed on the game interface of the captain. The command control is configured to enable or disable the command permission of the captain.

Operation 4: Detect that the command control is in an on state. In one embodiment, the command control includes an on state and an off state. When the command control is in the on state, the captain has the command permission of the team. The command control is in the off state by default.

Operation 5: Display skills possessed by team-member virtual characters. In one embodiment, skill icons of skills possessed by at least two team-member virtual characters are displayed. The captain virtual character and the team-member virtual characters may have a first preset number of skills. Each virtual character may have a second preset number of skills, and skills of different virtual characters may be the same or different.

Operation 6: Detect that a skill is triggered. In one embodiment, the captain triggers, via a triggering operation for a skill icon, the skill corresponding to the skill icon.

Operation 7: Determine a skill state. In one embodiment, the skill state includes a ready state and a cooldown state. When a skill is in the ready state, the skill is ready and may be used or cast immediately. When a skill is in the cooldown state, the skill has been used, and can be used again after a cooldown time.

When the skill state is the cooldown state, operation 8 is performed, and when the skill state is the ready state, operation 9 is performed.

Operation 8: Display prompt information. When a skill is in the cooldown state, the captain clicks/taps on the skill, and the prompt information is displayed on the game interface of the captain. The prompt information may be presented in the form of a text, an icon, a progress bar, or the like. The prompt information is configured for notifying the captain that the current skill is in the cooldown state.

Operation 9: Mark a skill. When a skill is in the ready state, the captain clicks/taps on the skill, and performs a marking operation on the skill.

Operation 10: Display a marked state. When a skill is in the ready state, the captain clicks/taps on the skill, performs the marking operation on the skill, and switches the skill from the ready state to the marked state. Meanwhile, a marking serial number is in a local region of or at a peripheral side of the skill icon corresponding to the skill.

Operation 11: Detect casting prompt information. The casting prompt information is configured for indicating that a team commander recommends casting the skill.

In some embodiments, the captain sequentially triggers transmission of the casting prompt information to the team member corresponding to each skill among the at least two skills according to the marking serial number.

Operation 12: Determine whether the marking serial number is 1. The team member determines whether the marking serial number of the marked skill is 1. The marking serial number of 1 indicates that the skill is recommended to be cast preferentially. If the marking serial number is not 1, operation 13 is performed. If the marking serial number is 1, operation 14 is performed.

Operation 13: The interface does not respond. If the marking serial number of the current skill of the team member is not 1, no other prompt information is displayed on the game interface.

Operation 14: Display the casting prompt information. If the marking serial number of the current skill of the team member is 1, a skill casting prompt is displayed above the skill icon on the game interface of the team member. In one embodiment, the skill casting prompt may include the avatar of the team commander or the text prompt information configured for recommending casting the skill.

Operation 15: Use the skill. In one embodiment, the skill is cast in response to a triggering operation performed by the team member on the skill icon.

Operation 16: The casting prompt information disappears. In one embodiment, after the team member casts the skill according to the skill casting prompt, on the game interface of the team member, the skill casting prompt disappears, indicating that the skill has been cast. Moreover, the marking serial number corresponding to the skill with the nth marking serial number is changed to the (n-1) th marking serial number.

Operation 17: Detect that the skill with the marking serial number 1 has been used. In one embodiment, the server transmits the information of the second client to the first client. The information indicating that the skill with the marking serial number 1 has been used is transmitted to the client of the captain.

Operation 18: The skill with the marking serial number 1 disappears, and the marking serial numbers of other skills are each decreased by one. After it is detected that the skill with the marking serial number 1 has been used, the captain deletes the skill with the marking serial number 1 from the marked skills, and sequentially decreases each of the marking serial numbers of subsequently marked skills by one.

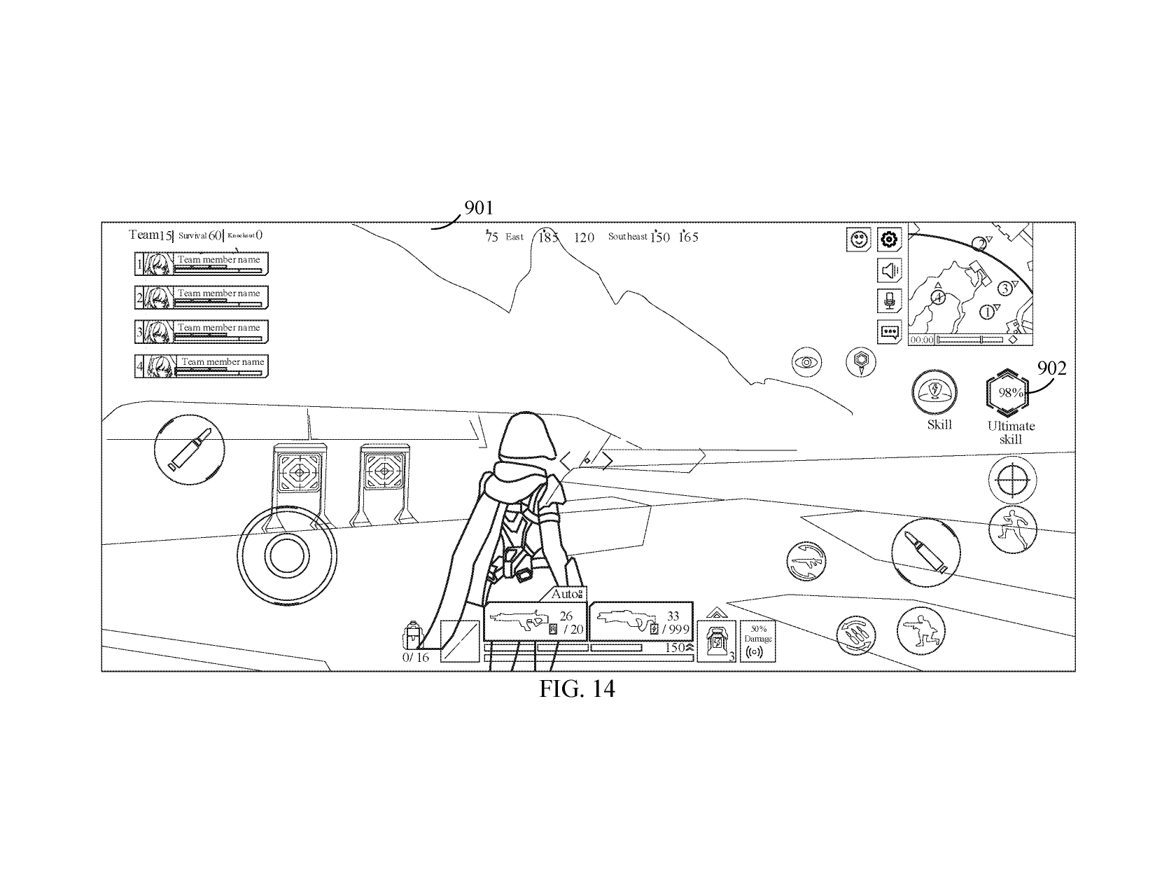

FIG. 16 illustrates a structural block diagram of an apparatus for casting a skill provided by an embodiment of this application. The apparatus has the functions of implementing the examples of the method for casting a skill described above. The functions may be implemented by hardware or by hardware executing corresponding software. The apparatus may be the server described above, or may be disposed in the server. As shown in FIG. 16, the apparatus 1600 may include a display module 1610 and a transmission module 1620.

The display module 1610 is configured to perform operation 220 in the embodiment of FIG. 3. The team-member virtual characters are virtual characters controlled by team members belonging to the same team. The display module 1610 is configured to perform operation 240 in the embodiment of FIG. 3. The marking serial number is configured for indicating the suggested casting order of the current skill among the at least two skills. The transmission module 1620 is configured to perform operation 260 in the embodiment of FIG. 3. The casting prompt information is configured for instructing the team member to cast the skill.

In some embodiments, the transmission module 1620 further includes a transmission submodule and a calculation submodule.

In an exemplary example, the transmission submodule is configured to perform operation 260a in the embodiment of FIG. 10. The casting prompt information is configured for instructing the team member to cast the skill with the first marking serial number. The calculation submodule is configured to perform operation 260b in the embodiment of FIG. 10. The remaining skills are skills that have not been cast among the at least two skills.

In an exemplary example, the display module 1610 is configured to perform operation 240a in the embodiment of FIG. 8.

In an exemplary example, the display module 1610 is configured to display, in response to a triggering operation on a first skill and a state of the first skill being cooldown, prompt information indicating that the first skill is being cooled down.

In an exemplary example, the display module 1610 is configured to perform operation 210 in the embodiment of FIG. 6. The display module 1610 is further configured to perform operation 220a in the embodiment of FIG. 6.

In some exemplary embodiments, the apparatus 1600 further includes a deletion module. In an exemplary example, the deletion module is configured to delete, when a target skill that is not cast in advance according to the marking order exists, the target skill from the at least two skills, and decrease the marking serial number of another skill that is cast behind the target skill among the at least two skills by one. In an exemplary example, the at least two skills include at least two skills corresponding to different team-member virtual characters, or at least two skills corresponding to the captain virtual character and the team-member virtual characters.

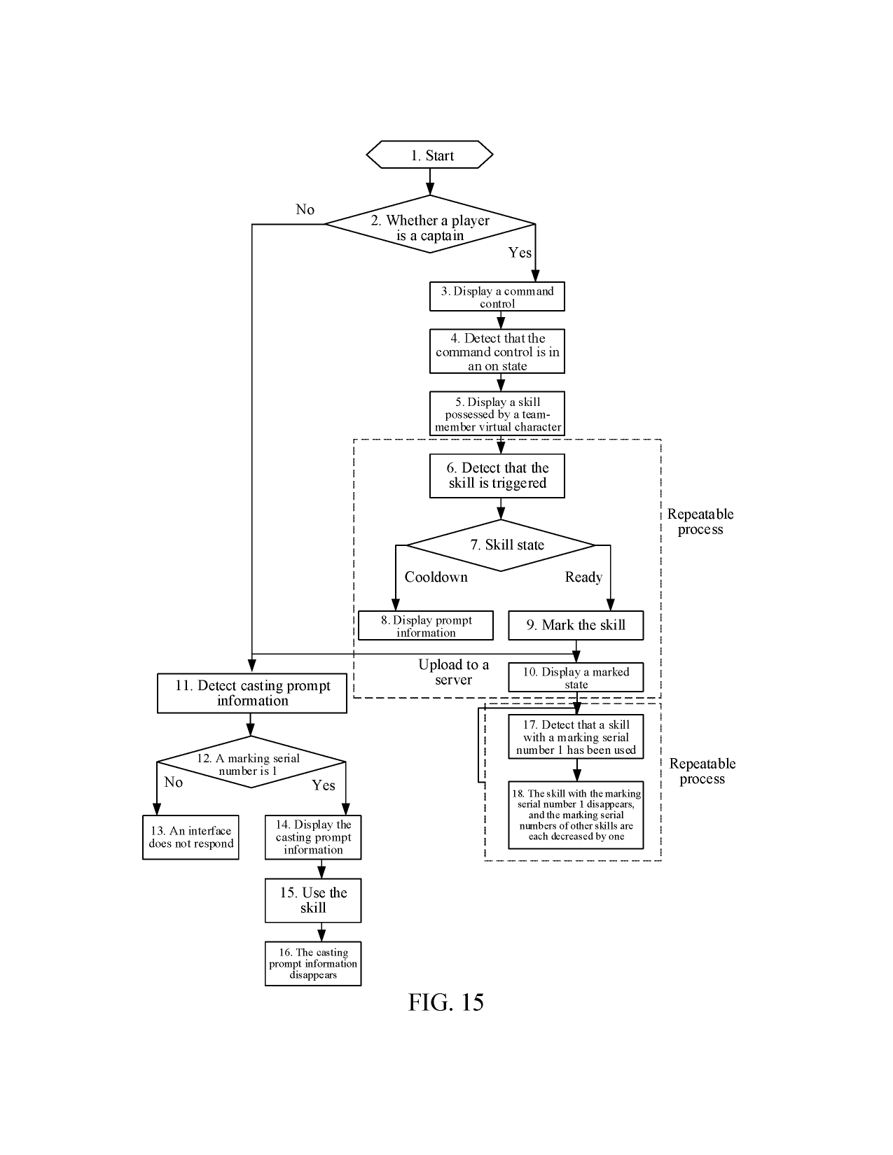

FIG. 17 illustrates a structural block diagram of an apparatus for casting a skill provided in an embodiment of this application. The apparatus has the functions of implementing the examples of the method for casting a skill described above. The functions may be implemented by hardware or by hardware executing corresponding software. The apparatus may be the server described above, or may be disposed in the server. As shown in FIG. 17, the apparatus 1700 may include a display module 1710 and a casting module 1720. The display module 1710 is configured to perform operation 320 in the embodiment of FIG. 12. The team-member virtual characters are virtual characters controlled by team members belonging to the same team. The display module 1710 is configured to perform operation 340 in the embodiment of FIG. 12. The casting prompt information being configured for indicating that a team commander recommends casting the skill. The casting module 1720 is configured to perform operation 360 in the embodiment of FIG. 12.

In an exemplary example, the casting prompt information includes at least one of: an avatar of the team commander; and text prompt information configured for recommending casting the skill. In an exemplary example, the casting prompt information is transmitted to a team member corresponding to each skill among at least two skills sequentially triggered according to marking serial numbers, where the marking serial numbers are obtained by sequentially marking the at least two skills by the team commander, and each marking serial number is configured for indicating a suggested casting order of a current skill among the at least two skills.

For specific definitions in one or more foregoing embodiments of the apparatus for casting a skill, reference may be made to the definitions for the method for casting a skill described above. Details are not repeated here. The modules of the apparatus described above may be implemented entirely or partially by software, hardware, or a combination thereof. The modules may be embedded in or independent of a processor of a computer device in the form of hardware, or may be stored in a memory of the computer device in the form of software, such that the processor invokes the modules to perform corresponding operations.

The serial numbers of the embodiments of this application are merely for description purposes but do not indicate the preference of the embodiments.

An embodiment of this application further provides a computer device. The computer device includes a processor and a memory, the memory having at least one computer program stored therein that, when loaded and executed by the processor, implements the method for casting a skill provided by the above method embodiments.

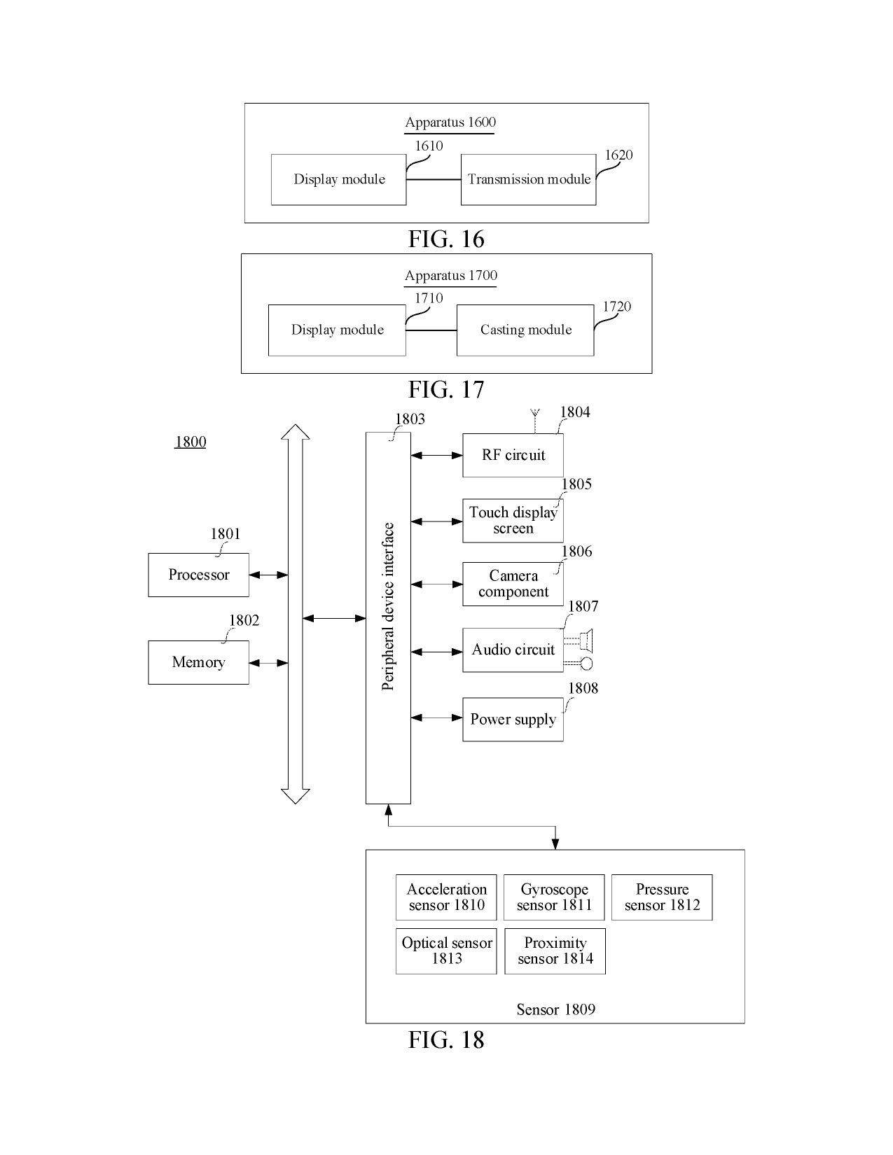

FIG. 18 illustrates a structural block diagram of a computer device 1800 provided by an exemplary embodiment of this application. The computer device 1800 may be a portable mobile terminal, for example, a smartphone, a tablet computer, an MP3 player, or an MP4 player. The computer device 1800 may alternatively be referred to as another name such as user equipment or a portable terminal. The computer device 1800 includes a processor 1801 and a memory 1802.

The processor 1801 may include one or more processing cores, such as a 4-core processor or an 8-core processor. The processor 1801 may be implemented in at least one hardware form of digital signal processing (DSP), field programmable gate array (FPGA), and programmable logic array (PLA). The processor 1801 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1801 may be integrated with a graphics processing unit (GPU) that is configured to render and draw content needing to be displayed on a display screen. In some embodiments, the processor 1801 may further include an AI processor that is configured to process computing operations related to machine learning.

The memory 1802 may include one or more computer-readable storage media. The computer-readable storage medium may be tangible and non-transitory. The memory 1802 may further include a high-speed random access memory and a non-volatile memory, such as one or more disk storage devices and flash storage devices. In some embodiments, the non-transitory computer-readable storage medium in the memory 1802 is configured to store at least one instruction, the at least one instruction being configured to be executed by the processor 1801 to implement the method for casting a skill provided in the embodiments of this application.

In some embodiments, the computer device 1800 may alternatively include a peripheral device interface 1803 and at least one peripheral device. The processor 1801, the memory 1802, and the peripheral device interface 1803 may be connected via a bus or a signal cable. Each peripheral device may be connected to the peripheral device interface 1803 via a bus, a signal cable, or a circuit board. Specifically, the peripheral device includes at least one of a radio frequency (RF) circuit 1804, a touch display screen 1805, a camera component 1806, an audio circuit 1807, and a power supply 1808. The peripheral device interface 1803 may be configured to connect the at least one peripheral device related to I/O to the processor 1801 and the memory 1802. In some embodiments, the processor 1801, the memory 1802, and the peripheral device interface 1803 are integrated on the same chip or circuit board. In some other embodiments, any one or two of the processor 1801, the memory 1802, and the peripheral device interface 1803 may be implemented on a single chip or circuit board. This is not limited in this embodiment. The RF circuit 1804 is configured to receive and transmit an RF signal, which is also referred to as an electromagnetic signal. The RF circuit 1804 communicates with a communication network and other communication devices through the electromagnetic signal. The RF circuit 1804 may further include a near field communication (NFC)-related circuit. The touch display screen 1805 is configured to display a user interface (UI). The UI may include graphics, text, icons, videos, and any combination thereof. The camera component 1806 is configured to capture images or videos. In one embodiment, the camera component 1806 includes a front-facing camera and a rear-facing camera. The audio circuit 1807 is configured to provide an audio interface between a user and the computer device 1800. The audio circuit 1807 may include a microphone and a speaker. The microphone is configured to acquire sound waves of a user and an environment, and convert the sound waves into electrical signals for inputting to the processor 1801 for processing, or inputting to the RF circuit 1804 for implementing voice communication. The power supply 1808 is configured to supply power to components in the computer device 1800. The power supply 1808 may be alternating current, direct current, a primary battery, or a rechargeable battery.

In some embodiments, the computer device 1800 further includes one or more sensors 1809. The one or more sensors 1809 include, but are not limited to, an acceleration sensor 1810, a gyroscope sensor 1811, a pressure sensor 1812, an optical sensor 1813, and a proximity sensor 1814. The acceleration sensor 1810 may detect acceleration on three coordinate axes of a coordinate system established by the computer device 1800. The pressure sensor 1812 may be disposed on a side frame of the computer device 1800 and/or a lower layer of the touch display screen 1805. It is configured to detect a holding signal of the user on the computer device 1800, and/or control an operable control on the UI interface according to a pressure operation of the user on the touch display screen 1805. The optical sensor 1813 is configured to acquire ambient light intensity. The proximity sensor 1814, also referred to as a distance sensor, is disposed on the front surface of the computer device 1800. The proximity sensor 1814 is configured to acquire a distance between a user and a front side of the computer device 1800. A person skilled in the art may understand that the foregoing structure does not constitute any limitation on the computer device 1800, and the computer device may include more components or fewer components than those shown in the figure, or some components may be combined, or a different component deployment may be used.

An embodiment of this application further provides a non-transitory computer-readable storage medium, having at least one program stored therein, the at least one program being loaded and executed by a processor to implement the method for casting a skill provided by the above method embodiments. An embodiment of this application further provides a computer program product, including at least one computer program that is stored in a computer-readable storage medium. The at least one computer program is read from the computer-readable storage medium and executed by a processor of a computer device, such that the computer device performs the method for casting a skill provided by the above method embodiments.

The term "a plurality of" in this specification means two or more. And/or describes an association relationship for describing associated objects and represents that three relationships may exist. For example, A and/or B may represent the following three cases: Only A exists, both A and B exist, and only B exists. The character "/" indicates that the associated objects are in an "or" relationship. In addition, the step numbers described in this specification merely show an execution order of the steps. In some other embodiments, the foregoing steps may not be performed based on the number order. For example, two steps with different numbers may be performed simultaneously, or two steps with different numbers may be performed based on an order contrary to the order shown in the figure. This is not limited in the embodiments of this application.

In this application, the term “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. A person of ordinary skill in the art can understand that all or some of the steps in the foregoing embodiments may be implemented by hardware, or by instructing related hardware by using a program. The program may be stored in a computer-readable storage medium. The above-mentioned storage medium may be a read-only memory, a magnetic disk, a compact disc, or the like.

What is claimed is:

1. A method for casting a skill in a virtual environment performed by a computer device, the method comprising:
displaying, in a graphical user interface, a virtual environment including skill icons of skills respectively possessed by at least two team-member virtual characters, the team-member virtual characters being controlled by team members belonging to a same team as a user of the computer device;
in response to a marking operation sequentially performed on at least two skills by the user of the computer device, displaying marking serial numbers respectively corresponding to the at least two skills at the corresponding skill icons, each marking serial number indicating a suggested casting order of a current skill among the at least two skills; and
sequentially triggering transmission of casting prompt information to a team member corresponding to each skill among the at least two skills.

2. The method according to claim 1, wherein the sequentially triggering transmission of casting prompt information to a team member corresponding to each skill among the at least two skills comprises:
triggering the transmission of the casting prompt information to a team member corresponding to a skill with a first marking serial number;
after the skill with the first marking serial number is cast, decreasing each of the marking serial numbers respectively corresponding to remaining skills among the at least two skills by one; and
triggering the transmission of the casting prompt information to a team member corresponding to a remaining skill with a second marking serial number.

3. The method according to claim 2, wherein the displaying marking serial numbers respectively corresponding to the at least two skills comprises:
in response to the marking operation sequentially performed on at least two skills and skill states of the at least two skills being ready, displaying the marking serial numbers respectively corresponding to the at least two skills according to the marking order.

4. The method according to claim 3, further comprising:
in response to a triggering operation on a first skill and a state of the first skill being cooldown, displaying prompt information indicating that the first skill is being cooled down.

5. The method according to claim 1, further comprising:
displaying a command control in the graphical user interface, the command control being configured to enable or disable a command permission; and
the displaying skill icons of skills respectively possessed by at least two team-member virtual characters comprising:
in response to a command enabling operation on the command control, displaying the skill icons of the skills respectively possessed by the at least two team-member virtual characters.

6. The method according to claim 1, further comprising:
when a target skill that is not cast in advance according to the marking order exists, deleting the target skill from the at least two skills and decreasing a marking serial number of another skill that is cast behind the target skill among the at least two skills by one.

7. The method according to claim 1, wherein the at least two skills comprise:
at least two skills corresponding to different team-member virtual characters; or
at least two skills corresponding to a captain virtual character and the team-member virtual characters.

8. A computer device, comprising a processor and a memory, the memory having a computer program stored therein, and the computer program when executed by the processor, causing the computer device to implement a method for casting a skill in a virtual environment including:
displaying, in a graphical user interface, a virtual environment including skill icons of skills respectively possessed by at least two team-member virtual characters, the team-member virtual characters being controlled by team members belonging to a same team as a user of the computer device;
in response to a marking operation sequentially performed on at least two skills by the user of the computer device, displaying marking serial numbers respectively corresponding to the at least two skills, each marking serial number indicating a suggested casting order of a current skill among the at least two skills; and
sequentially triggering transmission of casting prompt information to a team member corresponding to each skill among the at least two skills.

9. The computer device according to claim 8, wherein the sequentially triggering transmission of casting prompt information to a team member corresponding to each skill among the at least two skills comprises:
triggering the transmission of the casting prompt information to a team member corresponding to a skill with a first marking serial number;
after the skill with the first marking serial number is cast, decreasing each of the marking serial numbers respectively corresponding to remaining skills among the at least two skills by one; and
triggering the transmission of the casting prompt information to a team member corresponding to a remaining skill with a second marking serial number.

10. The computer device according to claim 9, wherein the displaying marking serial numbers respectively corresponding to the at least two skills comprises:
in response to the marking operation sequentially performed on at least two skills and skill states of the at least two skills being ready, displaying the marking serial numbers respectively corresponding to the at least two skills according to the marking order.

11. The computer device according to claim 10, wherein the method further comprises:
in response to a triggering operation on a first skill and a state of the first skill being cooldown, displaying prompt information indicating that the first skill is being cooled down.

12. The computer device according to claim 8, wherein the method further comprises:
displaying a command control in the graphical user interface, the command control being configured to enable or disable a command permission; and
the displaying skill icons of skills respectively possessed by at least two team-member virtual characters comprising:
in response to a command enabling operation on the command control, displaying the skill icons of the skills respectively possessed by the at least two team-member virtual characters.

13. The computer device according to claim 8, wherein the method further comprises:
when a target skill that is not cast in advance according to the marking order exists, deleting the target skill from the at least two skills and decreasing a marking serial number of another skill that is cast behind the target skill among the at least two skills by one.

14. The computer device according to claim 8, wherein the at least two skills comprise:
at least two skills corresponding to different team-member virtual characters; or
at least two skills corresponding to a captain virtual character and the team-member virtual characters.

15. A non-transitory computer-readable storage medium, having a computer program stored therein, the computer program, when executed by a processor of a computer device, causing the computer device to implement a method for casting a skill in a virtual environment including:
displaying, in a graphical user interface, a virtual environment including skill icons of skills respectively possessed by at least two team-member virtual characters, the team-member virtual characters being controlled by team members belonging to a same team as a user of the computer device;
in response to a marking operation sequentially performed on at least two skills by the user of the computer device, displaying marking serial numbers respectively corresponding to the at least two skills, each marking serial number indicating a suggested casting order of a current skill among the at least two skills; and
sequentially triggering transmission of casting prompt information to a team member corresponding to each skill among the at least two skills.

16. The non-transitory computer-readable storage medium according to claim 15, wherein the sequentially triggering transmission of casting prompt information to a team member corresponding to each skill among the at least two skills comprises:
triggering the transmission of the casting prompt information to a team member corresponding to a skill with a first marking serial number;
after the skill with the first marking serial number is cast, decreasing each of the marking serial numbers respectively corresponding to remaining skills among the at least two skills by one; and
triggering the transmission of the casting prompt information to a team member corresponding to a remaining skill with a second marking serial number.

17. The non-transitory computer-readable storage medium according to claim 16, wherein the displaying marking serial numbers respectively corresponding to the at least two skills comprises:
in response to the marking operation sequentially performed on at least two skills and skill states of the at least two skills being ready, displaying the marking serial numbers respectively corresponding to the at least two skills according to the marking order.

18. The non-transitory computer-readable storage medium according to claim 17, wherein the method further comprises:
in response to a triggering operation on a first skill and a state of the first skill being cooldown, displaying prompt information indicating that the first skill is being cooled down.

19. The non-transitory computer-readable storage medium according to claim 15, wherein the method further comprises:
displaying a command control in the graphical user interface, the command control being configured to enable or disable a command permission; and
the displaying skill icons of skills respectively possessed by at least two team-member virtual characters comprising:
in response to a command enabling operation on the command control, displaying the skill icons of the skills respectively possessed by the at least two team-member virtual characters.

20. The non-transitory computer-readable storage medium according to claim 15, wherein the method further comprises:
when a target skill that is not cast in advance according to the marking order exists, deleting the target skill from the at least two skills and decreasing a marking serial number of another skill that is cast behind the target skill among the at least two skills by one.
